(19) United States
(12) Patent Application Publication
(10) Pub. No.: US 2023/0276389 A1
(43) Pub. Date: Aug. 31, 2023

(54) METHOD FOR TRANSMITTING AND RECEIVING SIGNAL BY IAB NODE, AND APPARATUS THEREFOR

(71) Applicant: LG ELECTRONICS INC., Seoul (KR)

(72) Inventors: Hyunsoo KO, Seoul (KR); Hyangsun YOU, Seoul (KR); Jaenam SHIM, Seoul (KR)

(73) Assignee: LG ELECTRONICS INC., Seoul (KR)

(21) Appl. No.: 18/020,219

(22) PCT Filed: Aug. 9, 2021
(86) PCT No.: PCT/KR2021/010480

§ 371 Date: Feb. 7, 2023

(30) Foreign Application Priority Data
Aug. 7, 2020 (KR) 10-2020-0099450
Jul. 29, 2021 (KR) 10-2021-0100175

(51) Int. Cl. H04W 56/00

(52) U.S. Cl. CPC H04W 56/003

(57) ABSTRACT

The present disclosure provides a method for receiving an uplink signal by an integrated access and backhaul (IAB) node in a wireless communication system. In particular, the method comprises: obtaining timing information related to an uplink reception timing reference for a distributed unit (DU) of the IAB node; receiving a first uplink signal by the DU of the IAB node on the basis of the timing information; and receiving a downlink signal by a mobile-termination (MT) of the IAB node on the basis of the timing information, or transmitting a second uplink signal, wherein the reception of the first uplink signal by the DU of the IAB node and the reception of the downlink signal by the MT of the IAB node or the transmission of the second uplink signal are performed in the same time resource.

### CROSS-REFERENCE FOR RELATED APPLICATION(S)

This application is the National Stage filing under 35 U.S.C. 371 of International Application No. PCT/KR2021/010480, filed on Aug. 9, 2021, which claims the benefit of earlier filing date and right of priority to Korean Application Nos. 10-2020-0099450, filed on Aug. 7, 2020, and 10-2021-0100175, filed on Jul. 29, 2021, the contents of which are all incorporated by reference herein in their entireties.

### TECHNICAL FIELD

The present disclosure relates to a method of transmitting and receiving a signal by an Integrated Access and Backhaul (IAB) node and an apparatus therefor, and more particularly to a method of aligning transmit/receive timings of Mobile-Termination (MT) and Distributed Unit (DU) of an IAB node and transmitting and receiving a signal based on the aligned timings and an apparatus for the method

### BACKGROUND ART

As more and more communication devices demand larger communication traffic along with the current trends, a future-generation 5th generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle to everything (V2X), emergency service, and remote control), and mMTC is a future-generation mobile communication scenario characterized by low cost, low energy, short packet, and massive connectivity (e.g., Internet of things (IoT)).

### SUMMARY

The present disclosure provides a method of transmitting and receiving a signal by an Integrated Access and Backhaul (IAB) node and an apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

According to an embodiment of the present disclosure, a method of receiving an uplink signal by an Integrated Access and Backhaul (IAB) node in a wireless communication system includes acquiring timing information related to an uplink reception timing reference for a distributed unit (DU) of the IAB node, receiving a first uplink signal by the DU of the IAB node based on the timing information, and receiving a downlink signal or transmitting a second uplink signal by a mobile-termination (MT) of the IAB node based on the timing information, wherein the receiving of the first uplink signal by the DU of the IAB node and the receiving of the downlink signal or the transmitting of the second uplink signal by the MT of the IAB node are performed in the same time resource.

In this case, the uplink reception timing reference may be determined based on a downlink reception timing of the MT of the IAB node.

The uplink reception timing reference may be determined based on a Timing Advanced (TA) value for an uplink transmission timing of the MT of the IAB node.

The timing information may be received through a user equipment (UE) group common signal from a DU of a parent node.

The timing information may be transmitted to an MT of a child node.

The timing information may include a negative timing advanced (TA) value.

A first timing advanced (TA) value related to an uplink frame boundary for performing the receiving of the first uplink signal and the receiving of the downlink signal or the transmitting of the second uplink signal in the same time resource, and a second timing advanced (TA) value related to an uplink frame boundary for performing the receiving of the first uplink signal and the receiving of the downlink signal or the transmitting of the second uplink signal in different time resources may be different.

According to the present disclosure, an Integrated Access and Backhaul (IAB) node for receiving an uplink signal in a wireless communication system includes at least one transceiver, at least one processor, and at least one computer memory operatively connected to the at least one processor and configured to store instructions for causing the at least one processor to perform an operation when being executed, the operation including acquiring timing information related to an uplink reception timing reference for a distributed unit (DU) of the IAB node, receiving a first uplink signal by the DU of the IAB node based on the timing information through the at least one transceiver, and receiving a downlink signal or transmitting a second uplink signal by a mobile-termination (MT) of the IAB node based on the timing information through the at least one transceiver, wherein the receiving of the first uplink signal by the DU of the IAB node and the receiving of the downlink signal or the transmitting of the second uplink signal by the MT of the IAB node are performed through the at least one transceiver in the same time resource.

In this case, the uplink reception timing reference may be determined based on a downlink reception timing of the MT of the IAB node.

The uplink reception timing reference may be determined based on a Timing Advanced (TA) value for an uplink transmission timing of the MT of the IAB node.

The timing information may be received through a user equipment (UE) group common signal from a DU of a parent node.

The timing information may be transmitted to an MT of a child node.

The timing information may include a negative timing advanced (TA) value.

A first timing advanced (TA) value related to an uplink frame boundary for performing the receiving of the first uplink signal and the receiving of the downlink signal or the transmitting of the second uplink signal in the same time resource, and a second timing advanced (TA) value related to an uplink frame boundary for performing the receiving of the first uplink signal and the receiving of the downlink signal or the transmitting of the second uplink signal in different time resources may be different.

According to the present disclosure, an apparatus for receiving an uplink signal in a wireless communication system includes at least one processor, and at least one computer memory operatively connected to the at least one processor and configured to store instructions for causing the at least one processor to perform an operation when being executed, the operation including acquiring timing information related to an uplink reception timing reference for a distributed unit (DU) of the apparatus, receiving a first uplink signal by the DU of the apparatus based on the timing information, and receiving a downlink signal or transmitting a second uplink signal by a mobile-termination (MT) of the apparatus based on the timing information, wherein the receiving of the first uplink signal by the DU of the apparatus and the receiving of the downlink signal or the transmitting of the second uplink signal by the MT of the apparatus are performed in the same time resource.

According to the present disclosure, a computer readable storage includes at least one computer program for causing at least one processor to perform an operation, the operation including acquiring timing information related to an uplink reception timing reference for a distributed unit (DU) of the IAB node, receiving a first uplink signal by the DU of the IAB node based on the timing information, and receiving a downlink signal or transmitting a second uplink signal by a mobile-termination (MT) of the IAB node based on the timing information, wherein the receiving of the first uplink signal by the DU of the IAB node and the receiving of the downlink signal or the transmitting of the second uplink signal by the MT of the IAB node are performed in the same time resource.

According to the present disclosure, timing of IAB nodes may be properly aligned for Full Duplex or SDM (Spatial Division Multiplexing) and/or FDM (Frequency Division Multiplexing) based operations.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF DRAWINGS

FIG. 1 illustrates physical channels and a general signal transmission method using the physical channels in a 3rd generation partnership project (3GPP) system as an exemplary wireless communication system;

FIG. 2 illustrates a radio frame structure;

FIG. 3 illustrates a resource grid during the duration of a slot;

FIG. 4 illustrates exemplary mapping of physical channels in a slot;

FIG. 5 shows an example in which a UE adjusts transmission timing for uplink transmission;

FIG. 6 is a schematic diagram of an example for an integrated access and backhaul link;

FIG. 7 schematically illustrates an example of links among DgNB, RN, and UE;

FIG. 8 is a diagram for explaining operations in a Stand Alone (SA) mode and a Non Stand Alone (NSA) mode of an IAB node;

FIG. 9 schematically illustrates an example of a backhaul link and an access link;

FIG. 10 schematically illustrates an example of a parent link and a child link;

FIG. 11 is a diagram schematically illustrating a configuration between nodes;

FIG. 12 is a schematic diagram showing an example of an MT and a DU of an IAB node include a plurality of CCs;

FIGS. 13 to 14 are diagrams for explaining a Full Duplex operation;

FIG. 15 is a diagram for explaining an example of timing alignment for an IAB node;

FIGS. 16 to 17 are diagrams for explaining an overall operation procedure of an IAB node, a parent node, and a child node according to embodiments of the present disclosure;

FIG. 18 shows an example of a simultaneous transmission and reception operation;

FIG. 19 illustrates an exemplary communication system applied to the present disclosure;

FIG. 20 illustrates an exemplary wireless device applicable to the present disclosure; and

FIG. 21 illustrates an exemplary vehicle or autonomous driving vehicle applicable to the present disclosure.

### BEST MODE

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

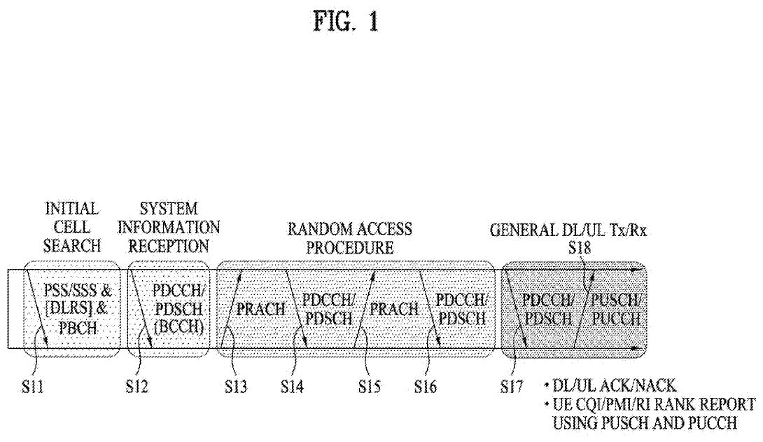

FIG. 1 illustrates physical channels and a general signal transmission method using the physical channels in a 3GPP system.

When a UE is powered on or enters a new cell, the UE performs initial cell search (S11). The initial cell search involves acquisition of synchronization to a BS. For this purpose, the UE receives a synchronization signal block (SSB) from the BS. The SSB includes a primary synchronization signal (PSS), a secondary synchronization signal (SSS), and a physical broadcast channel (PBCH). The UE synchronizes its timing to the BS and acquires information such as a cell identifier (ID) based on the PSS/SSS. Further, the UE may acquire information broadcast in the cell by receiving the PBCH from the BS. During the initial cell search, the UE may also monitor a DL channel state by receiving a downlink reference signal (DL RS).

After the initial cell search, the UE may acquire more detailed system information by receiving a physical downlink control channel (PDCCH) and a physical downlink shared channel (PDSCH) corresponding to the PDCCH (S12).

Subsequently, to complete connection to the BS, the UE may perform a random access procedure with the BS (S13 to S16). Specifically, the UE may transmit a preamble on a physical random access channel (PRACH) (S13) and may receive a PDCCH and a random access response (RAR) for the preamble on a PDSCH corresponding to the PDCCH (S14). The UE may then transmit a physical uplink shared channel (PUSCH) by using scheduling information in the RAR (S15), and perform a contention resolution procedure including reception of a PDCCH and a PDSCH signal corresponding to the PDCCH (S16).

When the random access procedure is performed in two steps, steps S13 and S15 may be performed as one step (in which Message A is transmitted by the UE), and steps S14 and S16 may be performed as one step (in which Message B is transmitted by the BS).

After the above procedure, the UE may receive a PDCCH and/or a PDSCH from the BS (S17) and transmit a physical uplink shared channel (PUSCH) and/or a physical uplink control channel (PUCCH) to the BS (S18), in a general UL/DL signal transmission procedure. Control information that the UE transmits to the BS is generically called uplink control information (UCI). The UCI includes a hybrid automatic repeat and request acknowledgement/negative acknowledgement (HARQ-ACK/NACK), a scheduling request (SR), channel state information (CSI), and so on. The CSI includes a channel quality indicator (CQI), a precoding matrix index (PMI), a rank indication (RI), and so on. In general, UCI is transmitted on a PUCCH. However, if control information and data should be transmitted simultaneously, the control information and the data may be transmitted on a PUSCH. In addition, the UE may transmit the UCI aperiodically on the PUSCH, upon receipt of a request/command from a network.

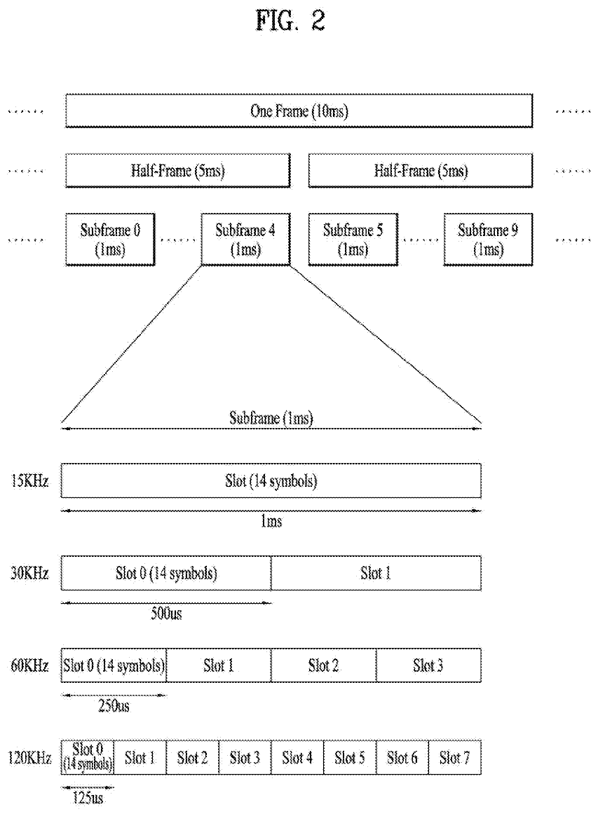

FIG. 2 illustrates a radio frame structure.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM(A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transform-spread-OFDM (DFT-s-OFDM) symbol).

Table 1 exemplarily illustrates that the number of symbols per slot, the number of slots per frame, and the number of slots per subframe vary according to SCSs in a normal CP case.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: number of symbols in a slot
* N^{frame, u}ₛₗₒₜ: number of slots in a frame
* N^{subframe, u}ₛₗₒₜ: number of slots in a subframe

Table 2 illustrates that the number of symbols per slot, the number of slots per frame, and the number of slots per subframe vary according to SCSs in an extended CP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The frame structure is merely an example, and the number of subframes, the number of slots, and the number of symbols in a frame may be changed in various manners. In the NR system, different OFDM(A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

In NR, various numerologies (or SCSs) may be supported to support various 5th generation (5G) services. For example, with an SCS of 15 kHz, a wide area in traditional cellular bands may be supported, while with an SCS of 30 kHz or 60 kHz, a dense urban area, a lower latency, and a wide carrier bandwidth may be supported. With an SCS of 60 kHz or higher, a bandwidth larger than 24.25 kHz may be supported to overcome phase noise.

An NR frequency band may be defined by two types of frequency ranges, FR1 and FR2. FR1 and FR2 may be configured as described in Table 3 below. FR2 may be millimeter wave (mmW).

TABLE 3

| Frequency Range | Corresponding | |
|---|---|---|
| designation | frequency range | Subcarrier Spacing |
| FR1 | 450 MHz-7125 MHz | 15, 30, 60 kHz |
| FR2 | 24250 MHz-52600 MHz | 60, 120, 240 kHz |

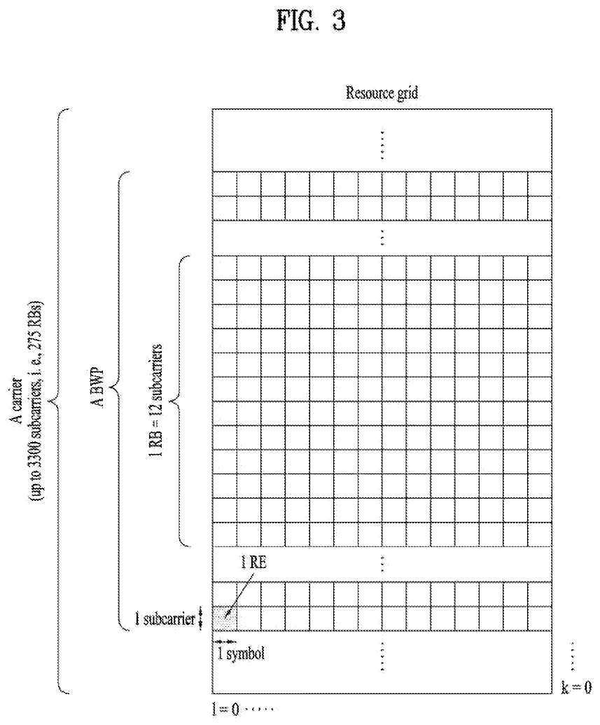

FIG. 3 illustrates a resource grid during the duration of one slot. A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A bandwidth part (BWP) may be defined by a plurality of consecutive (physical) RBs ((P)RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

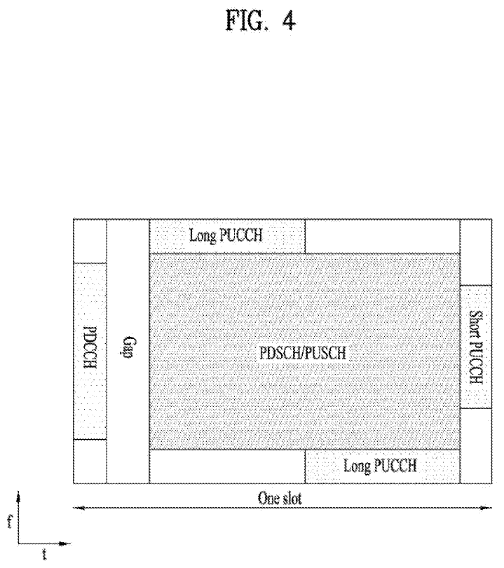

FIG. 4 illustrates exemplary mapping of physical channels in a slot.

A DL control channel, DL or UL data, and a UL control channel may all be included in one slot. For example, the first N symbols (hereinafter, referred to as a DL control region) in a slot may be used to transmit a DL control channel, and the last M symbols (hereinafter, referred to as a UL control region) in the slot may be used to transmit a UL control channel. N and M are integers equal to or greater than 0. A resource region (hereinafter, referred to as a data region) between the DL control region and the UL control region may be used for DL data transmission or UL data transmission. A time gap for DL-to-UL or UL-to-DL switching may be defined between a control region and the data region. A PDCCH may be transmitted in the DL control region, and a PDSCH may be transmitted in the DL data region. Some symbols at the time of switching from DL to UL in a slot may be configured as the time gap.

Now, a detailed description will be given of physical channels.

DL Channel Structures

An eNB transmits related signals on later-described DL channels to a UE, and the UE receives the related signals on the DL channels from the eNB.

(1) Physical Downlink Shared Channel (PDSCH)

The PDSCH carries DL data (e.g., a DL-shared channel transport block (DL-SCH TB)) and adopts a modulation scheme such as quadrature phase shift keying (QPSK), 16-ary quadrature amplitude modulation (16 QAM), 64-ary QAM (64 QAM), or 256-ary QAM (256 QAM). A TB is encoded to a codeword. The PDSCH may deliver up to two codewords. The codewords are individually subjected to scrambling and modulation mapping, and modulation symbols from each codeword are mapped to one or more layers. An OFDM signal is generated by mapping each layer together with a DMRS to resources, and transmitted through a corresponding antenna port.

(2) Physical Downlink Control Channel (PDCCH)

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

The PDCCH uses a fixed modulation scheme (e.g., QPSK). One PDCCH includes 1, 2, 4, 8, or 16 control channel elements (CCEs) according to its aggregation level (AL). One CCE includes 6 resource element groups (REGs), each REG being defined by one OFDM symbol by one (P)RB.

The PDCCH is transmitted in a control resource set (CORESET). The CORESET corresponds to a set of physical resources/parameters used to deliver the PDCCH/DCI in a BWP. For example, the CORESET is defined as a set of REGs with a given numerology (e.g., an SCS, a CP length, or the like). The CORESET may be configured by system information (e.g., a master information block (MIB)) or UE-specific higher-layer signaling (e.g., RRC signaling). For example, the following parameters/information may be used to configure a CORESET, and a plurality of CORESETs may overlap with each other in the time/frequency domain.
controlResourceSetId: indicates the ID of a CORESET.
frequencyDomainResources: indicates the frequency area resources of the CORESET. The frequency area resources are indicated by a bitmap, and each bit of the bitmap corresponds to an RB group (i.e., six consecutive RBs). For example, the most significant bit (MSB) of the bitmap corresponds to the first RB group of a BWP. An RB group corresponding to a bit set to 1 is allocated as frequency area resources of the CORESET.
duration: indicates the time area resources of the CORESET. It indicates the number of consecutive OFDMA symbols in the CORESET. For example, the duration is set to one of 1 to 3.
cce-REG-MappingType: indicates a CCE-to-REG mapping type. An interleaved type and a non-interleaved type are supported.
precoderGranularity: indicates a precoder granularity in the frequency domain.
tci-StatesPDCCH: provides information indicating a transmission configuration indication (TCI) state for the PDCCH (e.g., TCI-StateID). The TCI state is used to provide the quasi-co-location relation between DL RS(s) in an RS set (TCI-state) and PDCCH DMRS ports.
tci-PresentInDCI: indicates whether a TCI field is included in DCI.
pdcch-DMRS-ScramblingID: provides information used for initialization of a PDCCH DMRS scrambling sequence.

To receive the PDCCH, the UE may monitor (e.g., blind-decode) a set of PDCCH candidates in the CORESET. The PDCCH candidates are CCE(s) that the UE monitors for PDCCH reception/detection. The PDCCH monitoring may be performed in one or more CORESETs in an active DL BWP on each active cell configured with PDCCH monitoring. A set of PDCCH candidates monitored by the UE is defined as a PDCCH search space (SS) set. The SS set may be a common search space (CSS) set or a UE-specific search space (US S) set.

Table 4 lists exemplary PDCCH SSs.

TABLE 4

| | Search | | |
|---|---|---|---|
| Type | Space | RNTI | Use Case |
| Type0- | Common | SI-RNTI on a primary cell | SIB Decoding |
| PDCCH | | | |
| Type0A- | Common | SI-RNTI on a primary cell | SIB Decoding |
| PDCCH | | | |
| Type1- | Common | RA-RNTI or TC-RNTI on a | Msg2, Msg4 |
| PDCCH | | primary cell | decoding |
| | | | in RACH |
| Type2- | Common | P-RNTI on a primary cell | Paging |
| PDCCH | | | Decoding |
| Type3- | Common | INT-RNTI, SFI-RNTI, TPC- | |
| PDCCH | | PUSCH-RNTI, TPC-PUCCH- | |
| | | RNTI, TPC-SRS-RNTI, | |
| | | C-RNTI, MCS-C-RNTI, | |
| | | or CS-RNTI(s) | |
| UE | UE | C-RNTI, or MCS-C-RNTI, | User specific |
| Specific | Specific | or CS-RNTI(s) | PDSCH decoding |

The SS set may be configured by system information (e.g., MIB) or UE-specific higher-layer (e.g., RRC) signaling. S or fewer SS sets may be configured in each DL BWP of a serving cell. For example, the following parameters/information may be provided for each SS set. Each SS set may be associated with one CORESET, and each CORESET configuration may be associated with one or more SS sets. —searchSpaceId: indicates the ID of the SS set.
controlResourceSetId: indicates a CORESET associated with the SS set.
monitoringSlotPeriodicityAndOffset: indicates a PDCCH monitoring periodicity (in slots) and a PDCCH monitoring offset (in slots).
monitoringSymbolsWithinSlot: indicates the first OFDMA symbol(s) for PDCCH monitoring in a slot configured with PDCCH monitoring. The OFDMA symbols are indicated by a bitmap and each bit of the bitmap corresponds to one OFDM symbol in the slot. The MSB of the bitmap corresponds to the first OFDM symbol of the slot. OFDMA symbol(s) corresponding to bit(s) set to 1 corresponds to the first symbol(s) of the CORESET in the slot.
nrofCandidates: indicates the number of PDCCH candidates (e.g., one of 0, 1, 2, 3, 4, 5, 6, and 8) for each AL={1, 2, 4, 8, 16}.
searchSpaceType: indicates whether the SS type is CSS or USS.
DCI format: indicates the DCI format of PDCCH candidates.

The UE may monitor PDCCH candidates in one or more SS sets in a slot based on a CORESET/SS set configuration. An occasion (e.g., time/frequency resources) in which the PDCCH candidates should be monitored is defined as a PDCCH (monitoring) occasion. One or more PDCCH (monitoring) occasions may be configured in a slot.

Table 5 illustrates exemplary DCI formats transmitted on the PDCCH.

TABLE 5

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) |
| | and OFDM symbol(s) where UE may assume |
| | no transmission is intended for the UE |
| 2_2 | Transmission of TPC commands for |
| | PUCCH and PUSCH |
| 2_3 | Transmission of a group of TPC commands |
| | for SRS transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs. DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

UL Channel Structures

A UE transmits a related signal to the BS on a UL channel, which will be described later, and the BS receives the related signal from the UE through the UL channel to be described later.

(1) Physical Uplink Control Channel (PUCCH)

The PUCCH carries UCI, HARQ-ACK and/or scheduling request (SR), and is divided into a short PUCCH and a long PUCCH according to the PUCCH transmission length.

The UCI includes the following information.
SR: information used to request UL-SCH resources.
HARQ-ACK: a response to a DL data packet (e.g., codeword) on the PDSCH. An HARQ-ACK indicates whether the DL data packet has been successfully received. In response to a single codeword, a 1-bit of HARQ-ACK may be transmitted. In response to two codewords, a 2-bit HARQ-ACK may be transmitted. The HARQ-ACK response includes positive ACK (simply, ACK), negative ACK (NACK), discontinuous transmission (DTX) or NACK/DTX. The term HARQ-ACK is interchangeably used with HARQ ACK/NACK and ACK/NACK.
CSI: feedback information for a DL channel. Multiple input multiple output (MIMO)-related feedback information includes an RI and a PMI.

Table 6 illustrates exemplary PUCCH formats. PUCCH formats may be divided into short PUCCHs (Formats 0 and 2) and long PUCCHs (Formats 1, 3, and 4) based on PUCCH transmission durations.

TABLE 6

| | Length in | | | |
|---|---|---|---|---|
| PUCCH | OFDM symbols | Number | | |
| format | N_{symb}^{PUCCH} | of bits | Usage | Etc |
| 0 | 1-2 | ≤2 | HARQ, SR | Sequence |
| | | | | selection |
| 1 | 4-14 | ≤2 | HARQ, [SR] | Sequence |
| | | | | modulation |
| 2 | 1-2 | >2 | HARQ, CSI, | CP-OFDM |
| | | | [SR] | |
| 3 | 4-14 | >2 | HARQ, CSI, | DFT-s-OFDM |
| | | | [SR] | (no UE |
| | | | | multiplexing) |
| 4 | 4-14 | >2 | HARQ, CSI, | DFT-s-OFDM |
| | | | [SR] | (Pre DFT OCC) |

PUCCH format 0 conveys UCI of up to 2 bits and is mapped in a sequence-based manner, for transmission. Specifically, the UE transmits specific UCI to the BS by transmitting one of a plurality of sequences on a PUCCH of PUCCH format 0. Only when the UE transmits a positive SR, the UE transmits the PUCCH of PUCCH format 0 in PUCCH resources for a corresponding SR configuration. PUCCH format 1 conveys UCI of up to 2 bits and modulation symbols of the UCI are spread with an orthogonal cover code (OCC) (which is configured differently whether frequency hopping is performed) in the time domain. The DMRS is transmitted in a symbol in which a modulation symbol is not transmitted (i.e., transmitted in time division multiplexing (TDM)).

PUCCH format 2 conveys UCI of more than 2 bits and modulation symbols of the DCI are transmitted in frequency division multiplexing (FDM) with the DMRS. The DMRS is located in symbols #1, #4 , #7, and #10 of a given RB with a density of 1/3. A pseudo noise (PN) sequence is used for a DMRS sequence. For 2-symbol PUCCH format 2, frequency hopping may be activated.

PUCCH format 3 does not support UE multiplexing in the same PRBs, and conveys UCI of more than 2 bits. In other words, PUCCH resources of PUCCH format 3 do not include an OCC. Modulation symbols are transmitted in TDM with the DMRS.

PUCCH format 4 supports multiplexing of up to 4 UEs in the same PRBS, and conveys UCI of more than 2 bits. In other words, PUCCH resources of PUCCH format 3 include an OCC. Modulation symbols are transmitted in TDM with the DMRS.

(2) Physical Uplink Shared Channel (PUSCH)

The PUSCH carries UL data (e.g., UL-shared channel transport block (UL-SCH TB)) and/or UL control information (UCI), and is transmitted based a Cyclic Prefix-Orthogonal Frequency Division Multiplexing (CP-OFDM) waveform or a Discrete Fourier Transform-spread-Orthogonal Frequency Division Multiplexing (DFT-s-OFDM) waveform. When the PUSCH is transmitted based on the DFT-s-OFDM waveform, the UE transmits the PUSCH by applying transform precoding. For example, when transform precoding is not allowed (e.g., transform precoding is disabled), the UE may transmit the PUSCH based on the CP-OFDM waveform. When transform precoding is allowed (e.g., transform precoding is enabled), the UE may transmit the PUSCH based on the CP-OFDM waveform or the DFT-s-OFDM waveform. PUSCH transmission may be dynamically scheduled by the UL grant in the DCI or may be semi-statically scheduled based on higher layer (e.g., RRC) signaling (and/or Layer 1 (L1) signaling (e.g., PDCCH)) (configured grant). PUSCH transmission may be performed on a codebook basis or a non-codebook basis.

Table 7 shows DCI formats transmitted on the PDCCH.

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) |
| | and OFDM symbol(s) where UE may assume |
| | no transmission is intended for the UE |
| 2_2 | Transmission of TPC commands for |
| | PUCCH and PUSCH |
| 2_3 | Transmission of a group of TPC commands |
| | for SRS transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs. DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

Transmission Timing Adjustments

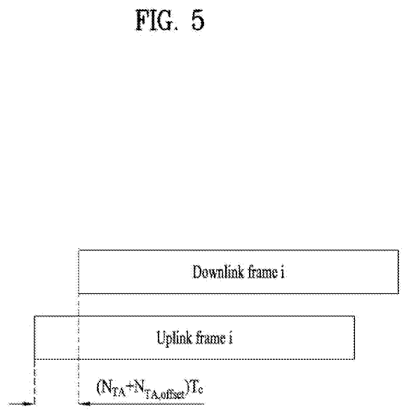

FIG. 5 shows an example in which a UE adjusts transmission timing for uplink transmission. Referring to FIG. 5, the UE may start transmitting an uplink frame before a time of (N_{TA}+N_{TA_offset})*T_{c} at a boundary of a downlink frame of a reference cell. In this case, N_{TA} is a TA (Timing Advanced) value, N_{TA_offset} is a TA offset value, and T_{c} represents a basic timing unit. On the other hand, when the UE transmits MsgA, N_{TA} is 0.

When the UE receives a TA offset value through a higher layer, the UE may use the provided TA offset value as N_{TA_offset}. If the UE is not provided with the TA offset value, the UE may use a default TA offset value as N_{TA_offset}.

If two uplink carriers are configured in the UE, the same N_{TA_offset} may be applied to both of the two uplink carriers.

When the UE receives a Timing Advance Command (TA) for a Timing Advance Group (TAG), the UE may adjust uplink transmission timings of PUSCH/SRS/PUCCH, etc. for all serving cells included in the TAG based on N_{TA_offset}. In other words, the same TA and the same N_{TA_offset} may be applied to all serving cells included in the TAG.

T_{A} for the TAG indicates a relative difference between a current uplink timing and a changed uplink timing by a multiple of 16*64*T_{c}/2^{u}. In this case, 2^{u} may be determined according to a subcarrier interval.

For example, in the case of RAR (Random Access Response), values of N_{TA} may be indicated through an index value of T_{A}. In detail, N_{TA}=T_{A}*16*64/2^{u} may be determined, and a first uplink transmission timing may be indicated from the UE after the RAR is received through N_{TA}.

In addition, in cases other than RAR, T_{A} may indicate values of N_{TA} through the index value of T_{A}, and in this case, N_{TA_new}=N_{TA_old}+(T_{A}−31)*16*64/2^{u} may be determined. Here, N_{TA_old} may be a current N_{TA} value, and N_{TA_new} may be a new N_{TA} value to be applied.

If an active UL BWP is changed between a time of applying adjustment for an uplink transmission timing and a time of receiving T_{A}, the UE may determine a value of T_{A} based on a subcarrier interval of the new active UL BWP. When the active UL BWP is changed after the uplink transmission timing is adjusted, the UE may assume that absolute T_{A} values before and after the active UL BWP change are the same.

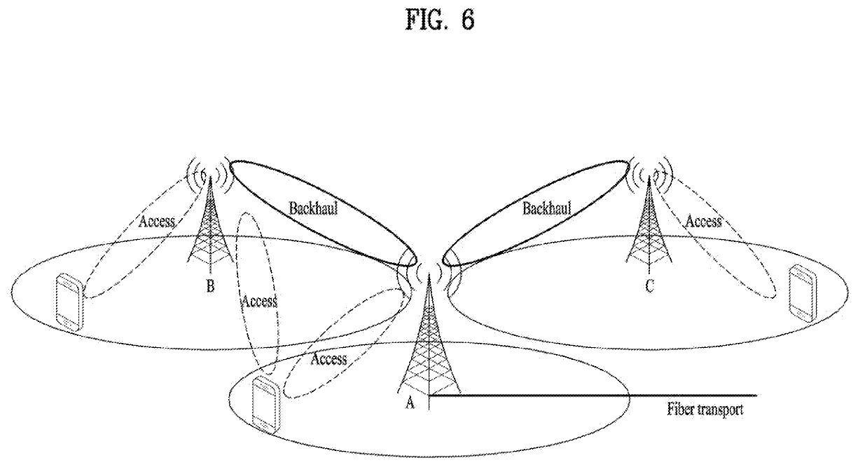

FIG. 6 is a schematic diagram of an example for an integrated access and backhaul link.

An example of a network with such integrated access and backhaul links is shown in FIG. 6, where an IAB (integrated access and backhaul) node or relay node (rTRP) can multiplex access and backhaul links in time, frequency, or space (eg, beam-based operations).

The operations of different links may be at the same or different frequencies (also referred to as ‘in-band’ and ‘out-band’ relays). Efficient support of an out-band relay is important in some NR deployment scenarios, but it is very important to understand in-band operational requirements, which mean close interaction with an access link operating at the same frequency, to accept duplex constraints and avoid/mitigate interference.

In addition, operating an NR system in the mmWave spectrum may present several unique challenges, including experiencing severe short-term blocking that may not be easily mitigated by current RRC-based handover mechanisms due to the larger time scale required to complete a procedure in comparison to short-term blocking.

To overcome short-term blocking in mmWave systems, it may require a fast RAN-based mechanism (which does not necessarily require intervention of a core network) for inter-rTRP switching.

The need to mitigate short-term blocking of an NR operation in mmWave spectrum with the need for easier deployment of a self-backhauled NR cell may lead to the need for the development of an integrated framework that enables fast switching of access and backhaul links.

In addition, Over-The-Air (OTA) coordination between rTRPs may be considered as mitigating interference and supporting end-to-end route selection and optimization.

The following requirements and aspects may need to be resolved by an integrated access and wireless backhaul (IAB) for NR.
Efficient and flexible operation for in-band and out-band broadcasting in indoor and outdoor scenarios
Multi-hop and redundant connections
End-to-end route selection and optimization
Backhaul link support with high spectrum efficiency
Legacy NR UE support

Legacy NR (new RAT) is designed to support half-duplex devices. In addition, half duplex of an IAB scenario is supported and worthy of being targeted. Furthermore, a full duplex IAB device may be studied.

In the IAB scenario, if each IAB node or Relay Node (RN) does not have scheduling capability, a Donor gNB (DgNB) must schedule the entire links among DgNB-related RNs and UEs. In other words, the DgNB may collect traffic information from all related RNs, make scheduling decisions for all links, and then inform each RN of schedule information.

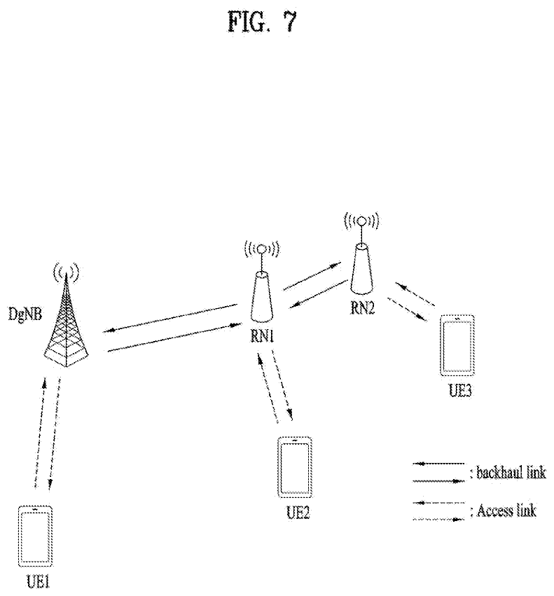

FIG. 7 schematically illustrates an example of links among DgNB, RN, and UE.

According to FIG. 7, a link between DgNB and UE1 may mean an access link, a link between RN1 and UE2 may mean an access link as well, and a link between RN2 and UE3 may mean an access link as well.

Likewise, according to FIG. 7, for example, a link between DgNB and RN1 and a link between RN1 and RN2 may mean backhaul links, respectively.

For example, as in the example of FIG. 7, a backhaul link and an access link may be configured, and in this case, the DgNB may not only receive a scheduling request of the UE1 but also receive a scheduling request of each of the UE2 and the UE3. Thereafter, the scheduling decision of two backhaul links and three access links may be made and the scheduling result may be notified. Thus, this centralized scheduling includes delay scheduling and latency issues.

On the other hand, distributed scheduling may be performed if each RN has a scheduling ability. This allows immediate scheduling for an uplink scheduling request of a UE, and allows a backhaul/access links to be utilized more flexibly by reflecting surrounding traffic conditions.

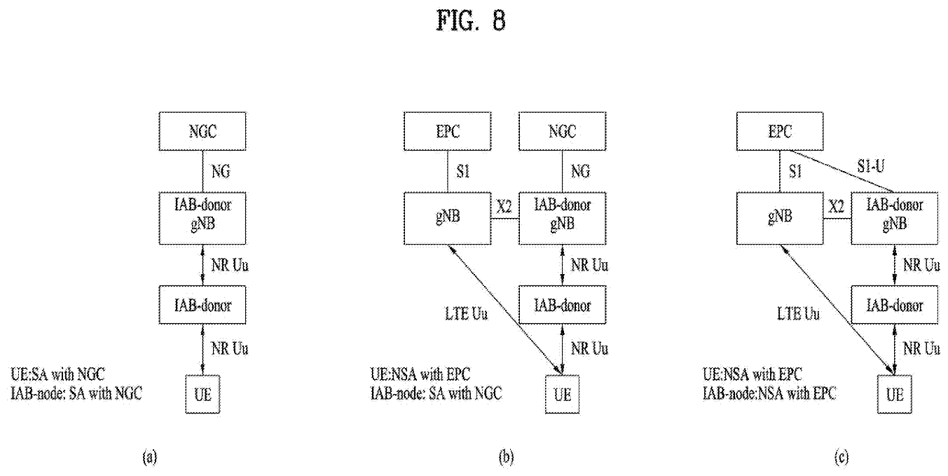

FIG. 8 is a diagram for explaining operations in a Stand Alone (SA) mode and a Non Stand Alone (NSA) mode of an IAB node.

The IAB node may operate in the SA or NSA mode. When the IAB node operates in the NSA mode, only an NR link may be used for backhauling. A UE accessing the IAB node may select an operation mode different from that of the IAB node. In other words, the UE may be additionally connected to a different type of CN (Core Network) from the connected IAB node. In this case, the UE may use (e) Decor or slicing for CN (Core Network) selection. IAB nodes operating in the NSA mode may be connected to the same eNB or to different eNBs.

In addition, UEs operating in the NSA mode may be connected to the same eNB as the IAB node to which the corresponding UE is connected, or may be connected to different eNBs. FIG. 8 shows an example of an SA mode with a Next Generation Core (NGC) and an NSA mode with an Evolved Packet Core (EPC).

In detail, FIG. 8 (a) shows an example of a UE and an IAB node connected to NGC and operating in an SA mode. FIG. 8(b) shows an example in which the IAB node is connected to the NGC and operates in the SA mode and the UE is connected to EPC and operates in the NSA mode. FIG. 8(c) shows an example in which the UE and the IAB node are connected to the EPC and operate in the NSA mode.

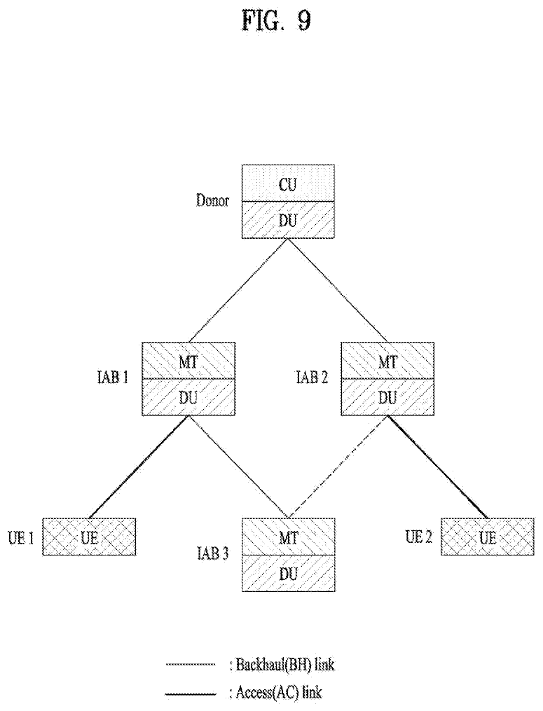

FIG. 9 schematically illustrates an example of a backhaul link and an access link.

As shown in FIG. 9, a link between a donor node and an IAB node or a link between IAB nodes is referred to as a backhaul link. On the other hand, a link between a donor node and an UE or a link between an IAB node and a UE is referred to as an access link. That is, a link between MT and parent DU or a link between DU and child MT may be called a backhaul link, and a link between DU and UE may be called an access link.

FIG. 8 schematically illustrates an example of a parent link and a child link.

As shown in FIG. 8, a link between an IAB node and a parent node is called a parent link, and a link between an IAB node and a child node/UE is called a child link. That is, a link between MT and parent DU is called a parent link, and a link between DU and child MT/UE is called a child link.

Yet, depending on interpretation or perspective, a link between an IAB node and a parent node may be called a backhaul link, and a link between an IAB node and a child node/UE may be called an access link.

An IAB node may receive a slot format configuration for communication with a parent node and a slot format configuration for communication with a child node/access UE.

As described above, an IAB node is configured with MT and DU, and a resource configuration for communication with parent node(s) by the MT is referred to as an MT configuration, and a resource configuration for communication with child node(s) and access UE(s) is referred to as a DU configuration.

More specifically, regarding an MT configuration, an IAB node may give a link direction information on a parent link between a parent node and the IAB node itself for communication with the parent node. Regarding a DU configuration, an IAB node may give a link direction and availability information on a child pink between a child node/access UE and the IAB node itself for communication with the child node/access UE.

Terms used in this specification may be as follows.
IAB node (IAB-node): a RAN node that supports radio access to the terminal(s) and supports wireless backhaul of access traffic.
IAB donor (IAB-donor): a RAN node that provides the core network the UE's interface and the radio backhaul function to the IAB node(s).

Hereinafter, each abbreviation may correspond to an abbreviation of the following terms.
IAB: Integrated Access and Backhaul
CSI-RS: Channel State Information Reference Signal
DgNB: Donor gNB (Donor gNB)
AC: Access
BH: Backhaul
DU: Distributed Unit
MT: Mobile terminal
CU: Centralized Unit
IAB-MT: IAB mobile terminal
NGC: Next-Generation Core network
SA: Stand-alone
NSA: non-stand-alone
EPC: Evolved Packet Core

On the other hand, from the IAB node MT point of view, time domain resource(s) of the following type(s) may be indicated for the parent link.
Downlink time resources;
uplink time resources;
Flexible time resources.

From an IAB node DU perspective, a child link may have time domain resource(s) of the following type(s).
Downlink time resources;
uplink time resources;
Flexible time resources;
Unavailable time resource(s) (resource(s) not used for communication on DU child link(s)).

The downlink, uplink, and flexible time resource type(s) of the DU child link may belong to one of the following two categories.
Hard: the corresponding time resource is always available for the DU child link;
Soft: The availability of the corresponding time resource for the DU child link may be explicitly and/or implicitly controlled by the parent node.

From the IAB node DU perspective, the child link has four types of time resources: downlink (DL), uplink (UL), flexible (F), and not available (NA). Here, the unavailable resource may mean that the resource is not used for communication on the DU child link(s).

Each of the downlink, uplink and flexible time resources of the DU child link may be hard or soft resources. As described above, hard resources may mean that communication is always possible in the DU child link. However, in the case of soft resources, communication availability in the DU child link may be explicitly and/or implicitly controlled by the parent node.

In such a situation, the setting in the link direction (DL/UL/F/NA) and link availability (hard/soft/NA) of the time resource for the DU child link may be called ‘DU configuration’.

This setting can be used for effective multiplexing and interference handling among IAB node(s). For example, this setting can be used to indicate which link is valid for the time resource between the parent link and the child link.

In addition, since configuring only a subset of the child node(s) can utilize time resources for DU operation, it can be used to adjust interference among the child node(s).

Considering this aspect, the DU configuration may be more effective when the DU configuration is semi-static and can be configured specifically for the IAB node.

On the other hand, similar to the SFI setting for the access link, the IAB node MT may have three types of time resources for the parent link: downlink (DL), uplink (UL), and flexible (F).

FIG. 9 is a diagram schematically illustrating a configuration between nodes.

As shown in \textcircled{1} of FIG. 9, the IAB node receives the MT setting that informs the link direction information on the parent link between the parent node and itself for communication with the parent node. In addition, as shown in \textcircled{2} of FIG. 9, a DU setting indicating link direction and link use availability information that can be used for communication to its own child link is set.

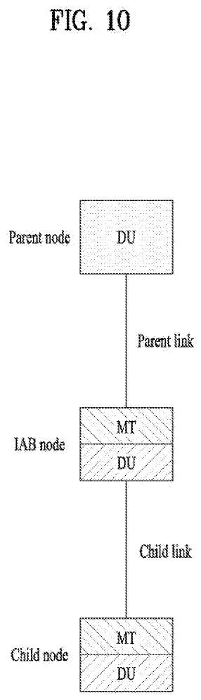

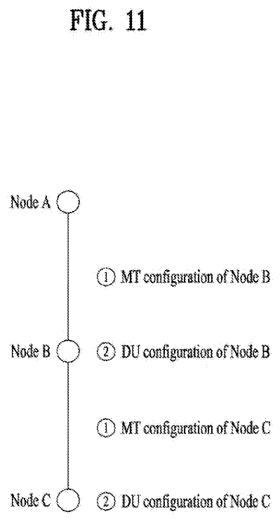

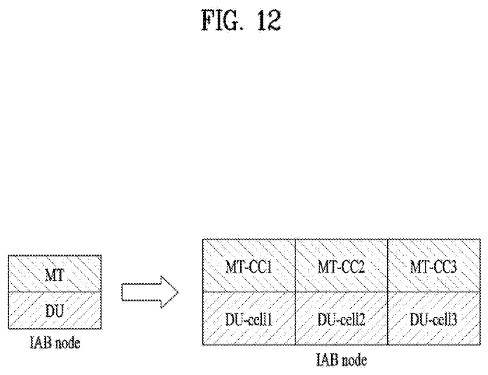

FIG. 10 schematically illustrates that an MT and a DU of an IAB node are configured with a plurality of CCs.

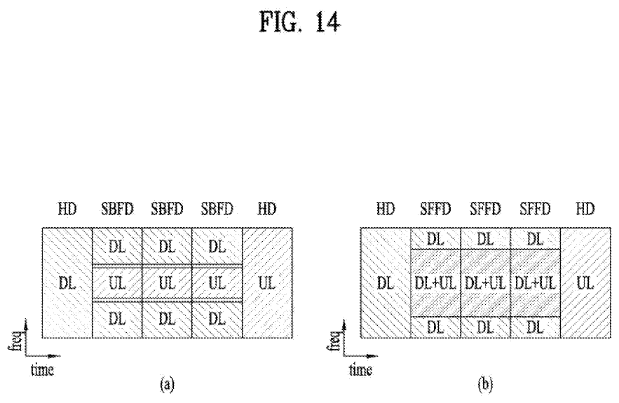

Referring to FIG. 10, an MT and a DU of an IAB node may be configured with a plurality of Component Carriers (CCs). In this case, different CCs may operate in the same or different frequency regions, or may use the same or different panels. For example, as shown in FIG. 14, there may be three CCs of each of the MT and the DU in the IAB node. In the figure, the three CCs present in the MT are referred to as MT-CC1, MT-CC2, and MT-CC3, respectively. In the case of the DU, CCs are replaced with cells and are referred to as DU-cell 1, DU-cell 2, and DU-cell 3, respectively.

In this case, one of TDM, SDM/FDM, and FD multiplexing methods may apply between a specific CC of the MT and a specific cell of the DU. For example, if a specific MT-CC and a specific DU-cell are located in frequency regions of different inter-bands, respectively, FD may apply between the corresponding MT-CC and the corresponding DU-cell. On the other hand, TDM may apply between an MT-CC and a DU-CC located in the same frequency region. In FIG. 14, MT-CC1, MT-CC2, DU-cell1, and DU-cell 2 have f1 as a center frequency, MT-CC3 and DU-cell 3 have f2 as a center frequency, and f1 and f2 may be positioned in an inter-band. In this case, from the perspective of the MT-CC1 (or the MT-CC2), it may operate by TDM with the DU-cell 1 and the DU-cell 2, but it may operate by FD with the DU-cell 3. On the other hand, from the perspective of the MT-CC3, it may operate by FD with the DU-cell 1 and the DU-cell 2, but may operate by TDM with the DU-cell 3.

On the other hand, different multiplexing methods may apply between an MT and a DU even within the same CC. For example, a plurality of parts may exist in an MT-CC and/or DU-cell. Such a part may mean, for example, a link transmitted via an antenna having the same center frequency but a physical location difference or a link transmitted via a different panel.

Alternatively, it may mean, for example, a link transmitted through a different BWP despite the same center frequency. In this case, for example, when two parts are present in the DU-cell 1, a specific MT-CC or a multiplexing type operating with a specific part in the specific MT-CC may be different for each part. The content of the following specification describes a case that a multiplexing type applying per pair of a CC of an MT and a cell of a DU, but the content of the specification may be extended to apply to a case that an MT and a DU are divided into a plurality of parts and that a multiplexing type applying per pair of a CC and part of the MT and a cell and part of the DU may be different.

Meanwhile, it may be considered that one IAB node is connected to two or a plurality of parent nodes. In this case, an IAB MT may be connected to two parent DUs using a dual-connectivity method.

An IAB node may have redundant route(s) to an IAB donor CU. For IAB nodes(s) operating in SA mode, an NR DC may be used to activate route redundancy in BH by allowing an IAB-MT to have BH RLC channel(s) and two parent nodes simultaneously.

A parent node may have to connect to the same IAB donor CU-CP that controls establishment and release of redundant route(s) through two parent nodes.

A parent node may obtain roles of a master node and an auxiliary node of an IAB-MT together with an IAB donor CU. An NR DC framework (e.g. MCG/SCG-related procedures) may be used to establish a dual radio link with parent node(s).

Initial Access in IAB Node

The IAB node may follow the same initial access procedure as the UE to initially establish a connection to a parent IAB node or an IAB-donor. SSB/CSI-RS based RRM measurement defined in Rel-15 NR may be a starting point for IAB node discovery and measurement methods.

For example, a search procedure between IAB nodes to which half-duplex constraints and multi-hop topologies are applied, including SSB configuration conflict prevention between IAB nodes and IAB node discovery based on CSI-RS, may be considered. In detail, the following two cases may be considered when considering a cell ID used by the IAB node.
Case 1: IAB-Donor and IAB node share the same cell ID
Case 2: IAB-Donor and IAB node use separate cell IDs

In addition, a mechanism for multiplexing RACH transmission from the UE and RACH transmission from the IAB node needs to be additionally considered.

In the case of SA, initial IAB node discovery by the MT may follow the same Rel-15 initial access procedure as the UE. The initial access procedure may include cell search, SI acquisition, and random access based on the same SSB as the SSB for the access UE in order to initially establish a connection to a higher IAB node or IAB-Donor.

In the case of NSA deployment, when the IAB-node MT performs initial access to the NR carrier (from an Access UE point of view), the same initial access procedure as in the SA deployment may be performed. In this case, SSB/RMSI periodicity assumed by the MT for initial access may be longer than 20 ms assumed by the Rel-15 UE, and for example, one of candidate values of 20 ms, 40 ms, 80 ms, and 160 ms may be selected.

However, in this case, a candidate parent IAB node/donor need to support both an NSA function for the UE and an SA function for the MT performing initial access through the NR carrier.

Scheduling Method Between Backhaul Link and Access Link

Downlink IAB node transmission (i.e., backhaul link transmission from an IAB node to a child IAB node provided by the IAB node and transmission of an access link from the IAB node to the UE receiving the IAB node service) may be scheduled by the IAB node itself

In contrast, uplink IAB transmission (i.e., backhaul link transmission from an IAB node to a higher IAB node or an IAB Donor) may be scheduled by the higher IAB node or the IAB Donor.

Synchronization and Timing Alignment of IAB Node

When it is assumed that synchronization is correct only when time synchronization is less than 3 us within the overlapping coverage between IAB nodes, TA (Timing Advanced) based OTA (Over-The-Air) synchronization may support up to 5 multi-hop IAB networks in FR2. However, TA based OTA synchronization may not be sufficient to support multi-hop IAB networks in FR1.

Possible timing alignment units between the IAB node/IAB Donor or within the IAB node may be 1) Slot level Alignment, 2) Symbol level Alignment, and 3) No Alignment.

IAB may support TA-based synchronization between IAB nodes including a plurality of backhaul hops. The following cases describe transfer timing alignments between an IAB node and an IAB-Donor.
1) Case #1: DL transmission timings between the IAB node and the IAB-Donor may be aligned. If the DL TX and the UL RX are not aligned in the parent node, additional information for timing alignment may be required in order for the child node to properly set the OTA-based timing and the DL TX timing for synchronization.
2) Case #2: A DL transmission timing and a UL transmission timing may be aligned in the IAB node.
3) Case #3: A DL reception timing and a UL reception timing may be aligned in the IAB node.
4) Case #4: When the IAB node performs transmission, Case #2 may be applied, and when the IAB node performs reception, Case #3 may be applied.
5) Case #5: Case #1 may be used for an access link timing, and Case #4 may be used for a backhaul link timing within the IAB node of a different time slot.
6) Case #6: The DL transmission timing of Case #1 and the UL transmission timing of Case #2 may be used. In this case, the DL transmission timing for all IAB nodes may be aligned with the DL timing of the parent IAB node or the DL timing of the donor. In addition, the UL transmission timing of the IAB node may be aligned with the DL transmission timing of the IAB node.
7) Case #7: The DL transmission timing of Case #1 and the UL reception timing of Case #3 may be used. In this case, the DL transmission timing for all IAB nodes may be aligned with the DL timing of the parent IAB node or the DL timing of the donor. Also, the UL reception timing of the IAB node may be aligned with the DL reception timing of the IAB node.

When alignment of the DL TX timing and the UL RX timing of the parent node in Case #7 does not match, there may be a need for additional information for alignment for the child node to properly configure the OTA-based timing and the DL TX timing for synchronization.

Among the above-described cases for timing alignment, Case #1 may be supported for both access and backhaul link transmission timing alignment, and Cases #2 to #5 may not be supported in the IAB.

When Case #6 is supported, the IAB node needs to be controlled by the parent node or a network.

In order to enable DL transmission alignment between IAB nodes, 1) the IAB node may perform uplink transmission of Case #1 and Case #6 in parallel. 2) In addition, the parent node may transmit additional information about a time difference of DL Tx and UL Rx timings between the IAB node and the parent node to the child node in order to correct potential misalignment of DL Tx timings in the child node.

In this case, the child node may compare a difference between the DL Tx timing and the BH Rx timing of the child node. If a signal difference of the parent node is greater than that measured in the child node, the child node may advance the TX timing, and if the signal difference is smaller than that measured in the child node, the TX timing may be delayed.

In the above example, for Case #6 UL transmission in another child node, a separate Rx timing may need to be maintained in the parent node.

Case #7 may be compatible with Rel-15 UE by introducing negative TA, and TDM between child IAB node/Rel-16 UE supporting a new TA value and child IAB node/UE not supporting the new TA value may be possible. In addition, in order to enable alignment between DL reception and UL reception within the IAB node, Case #7 may be applied to the child node by introducing the negative TA for the IAB node. In addition, an IAB node may apply a positive TA that enables symbol alignment rather than slot alignment between DL reception and UL reception.

Bandwidth Part (BWP)

In an NR system to which various embodiments of the present disclosure are applicable, up to 400 MHz per component carrier (CC) may be allocated/supported. When a UE operating in such a wideband CC always operates with a radio frequency (RF) module turned on for the entire CC, battery consumption of the UE may increase. Alternatively, considering various use cases (e.g., eMBB, URLLC, mMTC, and so on) operating within a single wideband CC, a different numerology (e.g., SCS) may be supported for each frequency band within the CC. Alternatively, each UE may have a different maximum bandwidth capability. In this regard, the BS may indicate to the UE to operate only in a partial bandwidth instead of the total bandwidth of the wideband CC. The partial bandwidth may be defined as a bandwidth part (BWP). In the frequency domain, a BWP may be a subset of contiguous common resource blocks defined for a numerology pi within bandwidth part i on a carrier, and one BWP may correspond to one numerology (e.g., SCS, CP length, slot/mini-slot duration, and so on).

The BS may configure one or more BWPs in one CC configured for the UE. Alternatively, when UEs are concentrated on a specific BWP, the BS may configure another BWP for some of the UEs, for load balancing. Alternatively, the BS may exclude some spectrum of the total bandwidth and configure both-side BWPs of the cell in the same slot in consideration of frequency-domain inter-cell interference cancellation between neighboring cells. In other words, The BS may configure at least one DL/UL BWP for a UE associated with the wideband CC, activate at least one of DL/UL BWP(s) configured at a specific time point (by L1 signaling (e.g., DCI), MAC signaling, or RRC signaling), and indicate switching to another configured DL/UL BWP (by L1 signaling, MAC signaling, or RRC signaling). Further, upon expiration of a timer value, the UE may switch to a predetermined DL/UL BWP. In this case, in order to switch different configured DL/UL BWPs, DCI format 1_1 or DCI format 0_1 may be used. The activated DL/UL BWP may be referred to as an active DL/UL BWP. During initial access or before an RRC connection setup, the UE may not receive a configuration for a DL/UL BWP from the BS. A DL/UL BWP that the UE assumes in this situation is defined as an initial active DL/UL BWP.

Here, the DL BWP is a BWP for transmitting and receiving a downlink signal such as a PDCCH and/or a PDSCH, and the UL BWP is a BWP for transmitting and receiving an uplink signal such as a PUCCH and/or a PUSCH.

Full Duplex Operation in NR System

In 5G, new service types such as XR (Extended Reality), AI-based service, and self-driving car are emerging. In addition, these services dynamically change traffic in both DL and UL directions, and require low latency in packet transmission. In addition, in a 5G service, a traffic load is expected to increase explosively to support various new use cases.

On the other hand, the existing semi-static or dynamic TDD UL/DL configuration has a transmission time delay problem and an interference problem between operators. FDD may be considered as a method to solve the time delay problem and interference problem between performing devices of the TDD method, but the existing FDD method has limitations in terms of efficient frequency resource utilization for DL/UL directions.

Therefore, for low latency and efficient resource utilization in NR, a full duplex operation in a single carrier is being discussed.

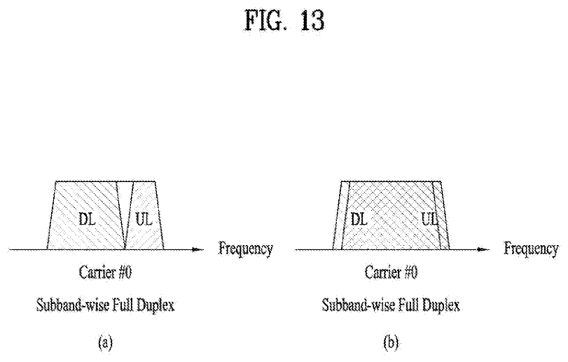

As an example of a method of applying full duplex in an intra-carrier, SB-FD (subband-wise full duplex) and SS-FD (spectrum-sharing full duplex) may be considered as shown in FIG. 13. With reference to FIG. 13(a), SB-FD is now described, and DL and UL transmission and reception may be performed through different frequency resources in the same carrier. That is, different frequency resources may be allocated to DL and UL for the same time resource.

With reference to FIG. 13(b), SS-FD DL is now described, and transmission and reception and DL and UL may be performed through the same frequency resource or overlapped frequency resources in the same carrier. That is, the same frequency resource or overlapping frequency resources may be allocated to DL and UL for the same time resource.

The above-described full-duplex operation may be used in combination with an existing half-duplex operation. In the conventional half-duplex based TDD operation, only some time resources may be used for full-duplex operation. An SB-FD or SS-FD operation may be performed on a time resource for performing a full-duplex operation.

FIG. 14 shows an example in which time resources operating in half duplex (HD) and time resources operating in full duplex (FD) such as SB-FD or SS-FD exist together. FIG. 14(a) shows that some time resources operate in SB-FD and the remaining time resources operate in HD. FIG. 14(b) shows that some time resources operate in SS-FD and the remaining time resources operate in HD. In this case, a unit of time resource may be, for example, a slot or a symbol.

Referring to FIG. 14 (a), in time resources operating with SB-FD, some frequency resources may be used as DL resources, and some other frequency resources may be used as UL resources. In addition, a guard sub-band (or guard frequency resource or guard subcarrier) that is not used for DL and UL and becomes empty may exist between DL and UL frequency resources.

Referring to FIG. 14 (b), in time resources operating with SF-FD, all frequency resources may be used for both DL and UL. Alternatively, in order to reduce an effect of interference (e.g., adjacent carrier interference (ACI)) from another adjacent carrier, some frequency resources at one or both ends of the carrier may not be used for DL and/or UL. That is, one or both ends of a carrier may be used as an unused guard band for both DL and UL. Alternatively, as in FIG. 14(b), in order to reduce ACI affecting UL reception, one or both ends of a carrier may be used only for DL transmission.

In the present disclosure, a frequency resource operating in DL among all frequency resources in a time resource operating in FD is referred to as a DL sub-band, and a frequency resource operating in UL is referred to as a UL sub-band.

The present disclosure proposes a method of performing multiplexing (simultaneous operation) through FDM using a bandwidth part (BWP) in which MT and DU of the IAB node are configured with different frequency resources. In addition, the present disclosure proposes a timing alignment method for supporting an In-band Full Duplex operation of a gNB and a UE.

In the existing IAB node, a TDM operation in which the DU and the MT operate through different time resources is performed. However, it may be necessary to perform resource multiplexing such as spatial division multiplexing (SDM)/frequency division multiplexing (FDM) and full duplexing (FD) between the DU and the MT for efficient resource management.

As described in FIG. 10, a link between the IAB node (IAB MT) and the parent node (parent DU) is referred to as a parent link, and a link between the IAB node (IAB DU) and the child node (child MT) (link) is referred to as a child link. In this case, conventionally, transmission and reception is performed based on a TDM operation between the parent link and the child link, but as described above, SDM/FDM and FD operations are required for efficient resource management, and a timing alignment method for resource multiplexing of SDM/FDM and FD may be required.

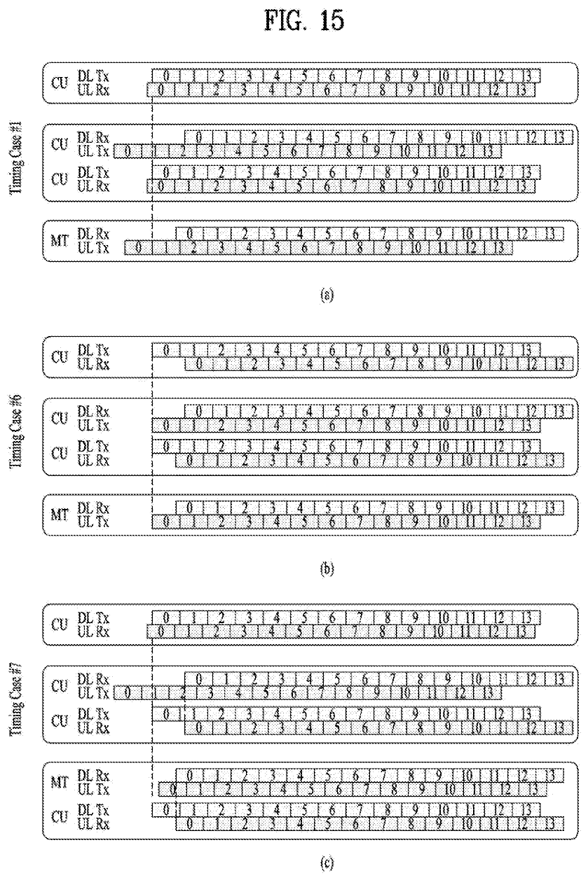

Prior to a detailed description, referring to FIG. 15, a Tx/Rx timing alignment method of an IAB node to be considered in an IAB environment will be described.

FIG. 15(a) is a diagram for explaining Timing Alignment Case #1.

Referring to FIG. 15(a), in Timing Alignment Case #1, DL transmission timings between an IAB node and an IAB-Donor may be aligned. This is a timing alignment method used by a Rel-16 IAB node, in which DL Tx timings of DU between IAB nodes are aligned.

When a DL Tx timing and a UL Rx timing of the parent node are not aligned, there is a need for additional timing alignment information for configuring an OTA based timing and a DL Tx timing related to synchronization by the child node. In this case, MT Tx timing=(MT Rx timing−TA) of the IAB node may be displayed. In addition, DU Tx timing=(MT Rx timing−TA/2−T_delta) of the IAB node may be displayed, and a T_delta value may be acquired from the parent node. That is, information on the T_delta value may be the aforementioned additional time information, and the parent node may transmit additional information corresponding to the T_delta value to the IAB node.

FIG. 15(b) is a diagram for explaining Timing Alignment Case #6.

Referring to FIG. 15(b), in Timing Alignment Case #6, DL transmission timings for all IAB nodes may be aligned with a DL transmission timing of the parent IAB node or the donor. In addition, a UL transmission timing of the IAB node may be aligned with the DL transmission timing of the IAB node.

In other words, Timing Alignment Case #6 is a method in which a MT UL Tx timing and a DU DL Tx timing of the IAB node are aligned.

In this case, a UL Tx timing of the MT is fixed, and thus a UL Rx timing of the parent DU receiving the UL signal transmitted by the MT may be delayed by a time corresponding to propagation delay of the parent DU and the MT compared with the UL Tx timing of the MT.

In addition, the UL Timing for each MT received by the DU may be different according to the MT of the child node transmitting the UL. When the IAB node uses timing alignment case #6, the UL Rx timing of the parent node is different from the existing one, and thus if the IAB node intends to use timing alignment case #6, the parent node needs to recognize the corresponding information.

FIG. 15(c) is a diagram for explaining Timing Alignment Case #7.

Referring to FIG. 15(c), DL transmission timings for all IAB nodes may be aligned with a DL transmission timing of the parent node or the donor. In addition, the UL reception timing of the IAB node may be aligned with the DL reception timing of the IAB node.

When the DL transmission timing and the UL reception timing in the parent node are not aligned, there may be a need for additional timing alignment information for configuring an OTA based timing and a synchronization DL Tx timing by the child node.

In other words, Timing Alignment Case #7 is a method in which a MT DL Rx timing and a DU UL Rx timing of the IAB node are aligned.

From an MT point of view, a transmit/receive timing may be the same as the existing IAB node (Rel-16 IAB node), and the UL Rx timing of the DU may be aligned with the DL Rx timing of the MT. The IAB node needs to be aligned with the UL Rx timing of the IAB node and to adjust the TA of the MTs of the child node in order for MTs of the child nod to transmit a UL signal.

Therefore, this timing alignment method may not be distinguished from Timing Alignment Case #1 in terms of an operation on the standard specification of the IAB node. Therefore, timing alignment case #7 described in the present disclosure may be replaced/interpreted with timing alignment case #1.

In the present disclosure, timing alignment may refer to slot-level alignment or symbol-level alignment.

Hereinafter, a Full Duplex operation for implementing an embodiment of the present disclosure will be described.

In the existing TDD system, different time resources may be used for DL and UL. In addition, when changing from UL to DL or from DL to UL, a switching time is required from a gNB, a UE, and/or an IAB node. In general, in TDD configuration, a gap time between UL and DL is not separately designated, but a gap time between DL and UL is designated.

However, this may not mean that the switching time is not required when switching from UL to DL. An actual switching time exists, which may be expressed as a difference in a predetermined time interval between a UL Frame and a Downlink Frame.

In other words, as seen from FIG. 5, a start time of the Uplink frame is located before a start time of the DL frame, and thus the operation may be performed with a slight time interval between an end of the Uplink frame and a start of the Downlink Frame. In this case, a value corresponding to the corresponding time interval is defined in 3GPP TS 38.133.

In detail, in the NR system, as shown in [Table 8], FDD and TDD in the FR1 band may be defined to commonly have a switching time of about 25600 Tc (about 15 us), and a switching time of about 13792 Tc (about 7 us) in the FR2 band may be defined.

In contrast, in the case of an LTE system, there may be a switching time between DL and UL in FDD, and a switching time of about 39936 Tc (about 20 us) may be configured between UL and DL in TDD.

TABLE 8

| Frequency Range and Band of cell | | NTA_offset |
|---|---|---|
| used for Uplink transmission | | (Unit: Tc) |
| FR1 | FDD band without LTE-NR co-existence case | 25600 |
| | TDD band without LTE-NR co-existence case | 25600 |
| | FDD band with LTE-NR co-existence case | 0 |
| | TDD band with LTE-NR co-existence case | 39936 |

| | |
|---|---|
| FR2 | 13792 |

A difference in timings between the Uplink frame and the Downlink frame in a BS or DU (i.e., a start boundary between the Uplink frame and the Downlink frame) may be transmitted to the UE or the IAB node through a TA (Timing Advanced) value.

In detail, as seen from FIG. 5, a UL transmission timing may be adjusted based on a final TA value obtained by adding N_{TA,offset} to a time gap between the Uplink frame and the DL frame, generated due to a switching time in N_{TA} that is a TA value obtained from the BS through RAR (Random Access Response), MAC-CE (Medium Access Control-Control Element), or the like. In this case, a formula for calculating the final TA value may be (N_{TA}+N_{TA,offset})Tc.

N_{TA,offset} may be a value indicated in ServingCellConfigCommon, may be indicated to the UE or the IAB node through cell specific system information, and may be commonly used to all users in a cell.

In the existing Unpaired Spectrum, time resources of UL and DL may be used differently. However, in a TDD configuration, time resources mainly allocated for DL may be relatively more than time resources allocated for UL. In this case, as a time to report ACK/NACK for a DL packet is delayed, overall long latency may occur. In addition, UL performance may be limited due to a small number of UL transmission occasions.

However, if Full Duplex, which simultaneously performs UL transmission and reception and DL transmission and reception through the same time resource in an Unpaired Spectrum, is allowed, it may be advantageous that the spectral efficiency of UL and DL is improved and latency is reduced.

In a Paired Spectrum, two different spectrums are used for UL and DL, respectively. However, UL spectrum may not be used because UL traffic is relatively small. Therefore, if UL transmission and reception and DL transmission and reception are simultaneously performed through the same time resource in some of the paired spectrums, such as introducing full duplex in unpaired spectrum, spectral efficiency may be improved.

However, if Full Duplex is allowed within the spectrum, a signal transmitted by the UE/BS/IAB node is mixed with its own received signal, and the signal transmitted thereby acts as self-interference with high signal strength, which may make it difficult to properly receive a desired signal.

Therefore, a method for reducing self-interference is essential for full duplex. Various methods may be used to reduce self-interference. For example, antenna separation, RF end Interference Cancellation (IC), digital end IC, etc. may be used.

In order to reduce the complexity of SIC (Self-Interference Cancellation), the SIC may be performed at a frequency end. In this case, if OFDM symbol boundaries of self-interference and a desired signal are aligned, demodulation/decoding of the SIC for self-interference and the desired signal may be performed with one FFT at the frequency end.

However, in existing TDD, when an offset may be configured between uplink frame and downlink frame times and the UE or the IAB node transmit UL, the TA value may be determined in consideration of the corresponding offset. Therefore, a difference occurs between a UL reception time and a DL transmission time in the BS or the DU. As a result, a difference as much as NTA_offset occurs between a time of receiving the desired signal of UL and a time of receiving self-interference of DL. Therefore, since self-interference and an OFDM symbol boundary of the desired signal are not aligned, it may not be easy to perform demodulation/decoding of the SIC and the desired signal at a frequency end.

Accordingly, according to the present disclosure, methods of aligning self-interference and an OFDM symbol boundary of a desired signal will be described.

In the embodiment of the present disclosure, an in-band environment is assumed, but the embodiment of the present disclosure may also be applied in an out-band environment. In addition, the content of the present disclosure may be applied to all cases in which a donor gNB (DgNB), a relay node (RN), and/or a UE perform a half-duplex operation and/or a full-duplex operation.

Hereinafter, methods for Tx-Rx timing alignment of an MT and a DU to transmit and receive a signal and/or a channel by the MT and the DU of the IAB node will be described.

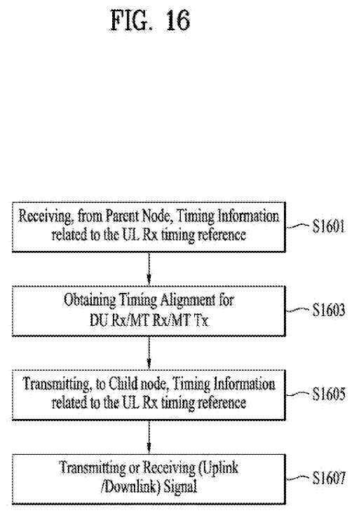

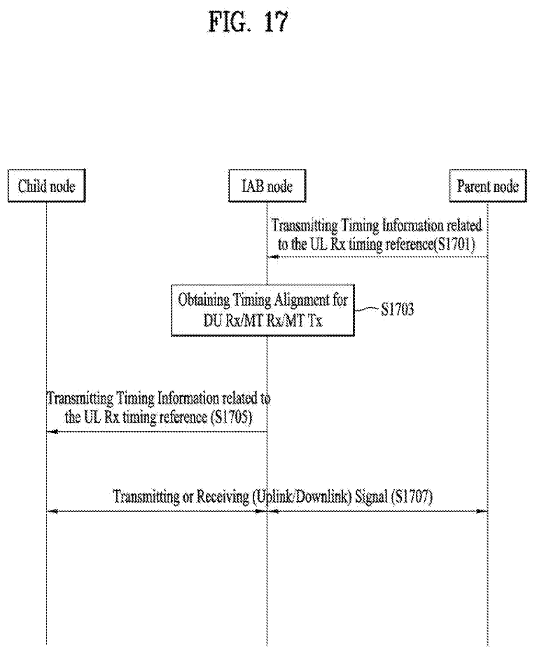

FIGS. 16 to 17 are diagrams for explaining an overall operation procedure of an IAB node, a parent node, and a child node according to embodiments of the present disclosure.

FIG. 16 is a diagram for explaining an overall operation procedure of an IAB node according to an embodiment of the present disclosure.

Referring to FIG. 16, the IAB node may receive timing information related to UL Rx timing reference from a parent node based on Embodiment #1, Embodiment #2, and/or Embodiment #4 (S1601). The IAB node may acquire a DU Rx timing, a MT Rx timing, and/or a MT Tx timing of the IAB node based on Embodiment #1, Embodiment #2, and/or Embodiment #4 (S1603). The IAB node may transmit timing information related to UL Rx timing reference to a child node based on Embodiment #1, Embodiment #2, and/or Embodiment #4 (S1605). In this case, the child node may acquire a DU Rx timing, a MT Rx timing, and/or a MT Tx timing of the child node based on the same operation as the IAB node of S1603.

The IAB node may transmit an uplink signal to the parent node or may receive a downlink signal from the parent node according to the DU Rx timing, the MT Rx timing, and/or the MT Tx timing that are aligned based on the Embodiment #1, Embodiment #2, and/or Embodiment #4. The IAB node may receive an uplink signal from the child node or may transmit a downlink signal to the child node according to the DU Rx timing, the MT Rx timing, and/or the MT Tx timing that are aligned based on Embodiment #1, Embodiment #2, and/or Embodiment #4 (S1607). When the IAB node of the present disclosure supports a multi-carrier operation, the operations of FIG. 16 may be performed by further considering Embodiment #3.

FIG. 17 is a diagram for explaining an overall operation procedure of an IAB node, a parent node, and a child node according to an embodiment of the present disclosure.

Referring to FIG. 17, a parent node may transmit timing information related to UL Rx timing reference to the IAB node based on Embodiment #1, Embodiment #2, and/or Embodiment #4 (S1701). The IAB node may align a DU Rx timing, an MT Rx timing, and/or an MT Tx timing of the IAB node according to Embodiment #1, Embodiment #2, and/or Embodiment #4 based on the timing information related to the UL Rx timing reference (S1703). Before transmitting the receiving a signal and/or a channel, the IAB node may transmit the timing information related to the UL Rx timing reference to the child node according to Embodiment #1, Embodiment #2, and/or Embodiment #4 for synchronization with the child node (S1705). In this case, the child node may acquire a DU Rx timing, an MT Rx timing, and/or an MT Tx timing of the child node based on the same operation as the IAB node of S1703.

When timings of the parent node, the IAB node, and the child node are aligned through S1701 to S1705, the IAB node may transmit an uplink signal to the parent node or receive a downlink signal from the parent node according to the DU Rx timing, the MT Rx timing, and/or the MT Tx timing that are aligned based on Embodiment #1, Embodiment #2, and/or Embodiment #4. In addition, the IAB node may receive an uplink signal from the child node or may transmit a downlink signal to the child node according to the DU Rx timing, the MT Rx timing, and/or the MT Tx timing that are aligned based on Embodiment #1, Embodiment #2, and/or Embodiment #4 (S1707). When the IAB node of the present disclosure supports a multi-carrier operation, the operations of FIG. 17 may be performed by further considering Embodiment #3.

In Rel-16, an OTA-based DL Tx timing alignment mechanism is specified to support ‘Timing Alignment Case #1’, which is assumed in a TDM (Time Division Multiplexing) operation between an MT and a DU of an IAB node. However, in Rel-17, simultaneous operation in which signal and/or channel transmission and reception operations are performed together is considered.

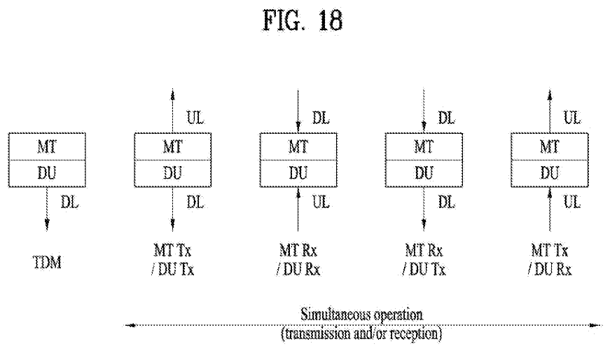

FIG. 18 shows an example of a simultaneous transmission and reception operation. Referring to FIG. 18, as shown in the leftmost part of FIG. 18, in Rel-16, only a TDM (Time Division Multiplexing) operation between the MT and the DU of the IAB node is supported. However, in Rel-17, it is considered to support simultaneous transmission/reception operation scenarios, such as an operation of the second to last pictures from the left in FIG. 18.

In detail, a second part of FIG. 18 shows a scenario in which simultaneous transmission and reception of MT Tx/DU Tx (i.e., UL transmission and DL transmission) of the IAB node is possible, and a third part of FIG. 18 shows a scenario in which simultaneous transmission and reception of MT Rx/DU Rx (i.e., DL reception and UL reception) of the IAB node is possible.

A fourth part of FIG. 18 shows a scenario in which simultaneous transmission and reception of MT Rx/DU Tx (i.e., DL transmission and DL reception) of the IAB node is possible, and the last part of FIG. 18 shows a scenario in which simultaneous transmission and reception of MT Tx/DU Rx (i.e., DL transmission and DL reception) of the IAB node is possible.

In order to support various simultaneous transmission/reception scenarios shown in FIG. 18, a timing alignment method for simultaneous transmission and reception needs to be defined based on a timing alignment mechanism for ‘case #6 (MT Tx/DU Tx)’ and ‘case #7 (MT Rx/DU Rx)’ of an IAB timing mode. As shown in FIG. 16, a new IAB timing mode for simultaneous transmission/reception scenarios shown in FIG. 16, such as MT Tx/DU Rx timing alignment of the IAB node and/or MT Rx/DU Tx timing alignment of the IAB node needs to be defined.

For example, Timing Alignment Case #8 and Timing Alignment Case #9 for timing alignment of the IAB node may be defined as follows.
Timing Alignment Case #8: Timing Alignment Case #1+Alignment of UL transmission timing of IAB node and UL reception timing of IAB node
Timing Alignment Case #9: Timing Alignment Case #1+Alignment of DL reception timing of IAB node and DL transmission timing of IAB node

According to the present disclosure, different Timing Alignment Cases for a simultaneous transmission and reception operation in addition to the aforementioned example may be defined, which will be described in detail.

### 1. Embodiment #1: MT Tx/DU Tx Timing Alignment

In the case of simultaneous MT Tx/DU Tx, an MT UL Tx time may be aligned with a DU DL Tx time, and the DU DL Tx time may be used as a timing reference for the MT UL Tx. Therefore, when applying the UL Tx time according to Timing Alignment Case #6, the IAB-MT may not need to apply the TA (Timing Advanced) value indicated by the gNB. That is, the IAB-MT may transmit a UL signal according to the MT UL Tx timing determined using the TA value determined by the DU DL Tx time. In this case, a TA value determined by the DU DL Tx time may be a positive TA value or a negative TA value. Here, if the positive TA value is used to transmit a UL signal at a timing before the defined UL symbol boundary by a degree corresponding to the positive TA value, the negative TA value may be used to transmit a UL signal at a timing after the defined UL symbol boundary by a degree corresponding to the negative TA value.

However, when the parent node receives a UL signal, a symbol boundary of the received UL signal may not be aligned with a symbol boundary of another UL signal. In addition, since the IAB nodes are randomly located and transmit signals and/or channels at physically different locations, propagation delays may not be the same. Therefore, when a multi-IAB MT transmits a UL signal, UL signals transmitted by the IAB MTs may have different symbol boundaries that are not aligned, and the parent nodes may receive UL signals that are not aligned (i.e., having different symbol boundaries). However, depending on the IAB-DU implementation, asynchronous reception may or may not be allowed. Therefore, the aforementioned Timing Alignment Case #6 needs to be applied according to a network configuration.

When a network allows a simultaneous MT Tx/DU Tx transmission and reception operation, the MT may apply a TA value determined by a DU DL Tx time and may transmit a UL signal. In addition, when the network allows both TDM and the simultaneous MT Tx/DU Tx transmission and reception operation, the IAB-MT may apply one of two TA values according to an IAB resource multiplexing method. For example, when IAB resource multiplexing is TDM, the IAB-MT may apply a first TA value for TDM and may transmit a UL signal. When IAB resource multiplexing is SDM/FDM or intends to support FD to perform the simultaneous MT Tx/DU Tx transmission and reception operation, the IAB-MT may apply a second TA value for the simultaneous MT Tx/DU Tx transmission and reception operation and may transmit a UL signal.

### 2. Embodiment #2: MT Tx/DU Tx, MT Rx/DU Tx, and MT Tx/DU Rx Timing Alignment

In the case of a simultaneous MT Rx/DU Rx transmission and reception operation, a DU UL Rx timing may be aligned with an MT DL Rx timing. That is, Timing Alignment Case #7 may be followed. When the IAB-DU determines to use a UL Rx timing of Timing Alignment Case #7, the DU of the parent node may also indicate timing information related to the UL Rx timing reference to the IAB node.

In this case, the timing information related to the UL Rx timing reference indicated by the DU of the parent node may include at least one of the following information.
1) Negative initial TA value for IAB node
2) Positive TA values that enable symbol alignment rather than slot alignment
3) Offset value relative to the most recent TA value, effectively allowing negative TA value to be applied.

A reference time for DU UL reception may be changed according to the MT DL Rx timing. Therefore, when the UL Rx timing reference is changed, the DU may be requested to indicate timing information to the IAB node.

When the characteristic of the UL Rx timing reference is a cell specific value, a network may indicate the timing information related to the UL Rx timing reference through a cell specific message such as system information or a UE group specific message such as DCI or a MAC-CE.

For example, the DU may transmit the timing information related to the UL Rx timing reference to the IAB node through UE group specific-DCI. In this case, UE group specific-DCI including the timing information related to the UL Rx timing reference may be scrambled using a random network temporary identifier (RNTI) corresponding to the timing information. Therefore, the IAB node performs a Cyclic Redundancy Check (CRC) check with an RNTI corresponding to the timing information, and when the CRC is checked, the IAB node may acquire the corresponding timing information from the corresponding UE group specific-DCI.

In addition, the corresponding UE group specific-DCI may be transmitted through a search space set and/or a control resource set (CORESET) configured for the corresponding UE group specific-DCI. Therefore, when the IAB node determines to use the UL Rx timing of Timing Alignment Case #7, the IAB node may monitor the search space set and/or the control resource set (CORESET) configured for the corresponding UE group specific-DCI in order to receive the timing information from the DU before transmitting and receiving other DL/UL signals. For example, the UE group specific-DCI may be GC (Group Common)-DCI.

In the case of the simultaneous MT Rx/DU Tx transmission and reception operation and MT Tx/DU Rx transmission and reception operation, interference to the IAB node may be reduced through Symbol level Timing Alignment of the MT and the DU.

In the case of the simultaneous MT Rx/DU Tx transmission and reception operation, a timing difference between MT DL Rx and DU DL Tx needs to be within a Cyclic Prefix (CP) length for Symbol level Timing Alignment. Thus, based on these facts, the simultaneous MT Rx/DU Tx transmission and reception operation based on Symbol level Timing Alignment needs to be performed in a small cell coverage (e.g., less than 100 m).

In the case of the simultaneous MT Tx/DU Rx transmission and reception operation, when Symbol level Timing Alignment is used, the IAB-MT UL Tx timing may be the same as the reception timing reference of an IAB-DU UL signal/channel. The reception timing reference of the IAB-DU UL signal/channel may be determined according to a TA value of the IAB-MT UL Tx of the child node, and thus the IAB-DU may indicate information related to the UL Rx timing reference to the IAB-MT of the child node.

When the IAB-DU transmits the information related to the UL Rx timing reference to the IAB-MT of the child node, the IAB-DU may indicate the timing information related to the UL Rx timing reference to the IAB-MT of the child node through a cell specific message such as system information or a UE group specific message such as DCI or MAC-CE.

For example, the IAB-DU may transmit the timing information related to the UL Rx timing reference to the child node through UE group specific-DCI. In this case, UE group specific-DCI including the timing information related to the UL Rx timing reference may be scrambled using a random network temporary identifier (RNTI) corresponding to the timing information. Therefore, the child node may perform Cyclic Redundancy Check (CRC) with an RNTI corresponding to the timing information, and when the CRC is checked, the corresponding timing information may be obtained from the corresponding UE group specific-DCI.

In addition, the corresponding UE group specific-DCI may be transmitted through a search space set and/or a control resource set (CORESET) configured for the corresponding UE group specific-DCI. Therefore, the child node may monitor the search space set and/or the Control Resource Set (CORESET) configured for the corresponding UE group specific-DCI in order to receive the timing information from the IAB-DU before transmitting and receiving other DL/UL signals. For example, the UE group specific-DCI may be Group Common (GC)-DCI.

In detail, when the IAB node performs Full Duplex (e.g., MT Rx/DU Tx simultaneous transmission and reception or MT Tx/DU Rx simultaneous transmission and reception) in Timing Alignment Case #7 (e.g., MT Rx/DU Rx simultaneous transmission and reception), a location of the UL reception timing for DU of the IAB-DU or the parent node may be changed, as described above in Embodiment #2. Change of the UL reception timing may be indicated to the MT of the child node or the IAB-MT through the timing information related to the UL Rx timing reference, and a value of the corresponding timing information may be commonly applied to IAB-MTs and/or MTs of the child node.

In addition, the value of the corresponding timing information may be changed based on the MT Rx of Timing Alignment Case #7, or may be changed based on the MT Tx in MT Tx/DU Rx simultaneous transmission and reception of IAB Full Duplex.

In addition, even if the IAB node is at a fixed location, MT Rx and MT Tx may be changed according to selection of a beam used for multi-path or beamforming. Therefore, the UL timing applied to the IAB-MT and/or the MT of the child node needs to be changed based on change of MT Rx and MT Tx.

To this end, in order to effectively indicate the changed UL timing, a TV value to be applied to the IAB-MT or MTs of the child node may be updated using DCI specific to the IAB-MT or the MT of the child node (e.g., UE group specific-DCI).

In more detail, a DCI format indicating an IAB specific resource, such as DCI format 2-5, may use a CRC scrambling with an AI-RNTI, and the corresponding DCI format may be DCI that is commonly applied to the IAB-MTs or the MTs of the child node. That is, the DCI format may be one type of UE group specific-DCI.

Therefore, resources to which Timing Alignment Case #7 or Full Duplex are applied may be indicated to IAB-MTs or MTs of the child node through the corresponding DCI format. In addition, a TA value to be applied in a corresponding resource may be indicated through corresponding DCI or a separate DCI. The indicated TA value is a value that is additionally applied to information on a TA command and TA update received from an existing RAR grant or UE Specific MAC-CE, and may be used as a TA update value applicable only to the corresponding resource.

As another method, a method of applying a TA value included in DCI indicated through a specific search space similarly to the above may be introduced. That is, in the above example, the corresponding DCI format may be replaced with DCI received through a specific search space, a specific search space set, or a specific CORESET and may be applied. In addition, the aforementioned specific search space, specific search space set, or specific CORESET may be commonly configured to the IAB-MTs or the MTs of the child node. Alternatively, a method of indicating an additional TA offset value through a MAC-CE may also be considered.

### 3. Embodiment #3: Multi-Carrier Support

In a multi-carrier scenario, an IAB resource multiplexing mode (e.g., TDM and simultaneous transmission and reception) may be operated independently for each carrier. In addition, a timing alignment case for IAB may be independently applied.

For example, in an IAB node that supports carrier aggregation (CA), when a plurality of carriers including carrier #1 and carrier #2 are aggregated, carrier #1 may transmit and receive a signal by an IAB node using a TDM method and carrier #2 may support simultaneous transmission and reception of signals using an SDM/FDM method. In addition, carrier #1 may transmit and receive a signal based on Timing Alignment Case #6, and carrier #2 may transmit and receive a signal based on Timing Alignment Case #7. As another example, carrier #1 may support simultaneous MT Rx/DU Rx transmission and reception, and carrier #2 may support simultaneous MT Tx/DU Rx transmission and reception.

In addition, in a CA scenario, timing information for Slot/Symbol level Alignment between an MT and a DU (e.g., timing information related to the UL Rx timing reference in Example #2) may be indicated through a PCell and/or a PScell. The indicated timing information may be applied to a target carrier. In addition, timing information related to the timing reference may be shared within a Timing Advanced Group (TAG).

For example, in the above example, when a plurality of carriers including carrier #1 and carrier #2 are aggregated, if the timing information related to the timing reference is transmitted using carrier #1 as a target carrier through a PCell and/or a PSCell, the IAB node receiving the corresponding timing information may determine timing alignment by applying the corresponding timing information only to carrier #1.

In this case, the PCell and/or the PSCell may transmit timing information for carrier #1 and timing information for carrier #2 to the IAB node, respectively. In this case, the timing information for carrier #1 may include an identifier (e.g., Carrier Indicator Field (CIF)) of carrier #1 to indicate that the timing information is applied to carrier #1. When the corresponding timing information is included in the DCI, the identifier of the carrier may also be included in the corresponding DCI. If the corresponding timing information is included in system information and/or MAC-CE, the carrier identifier may also be included in the corresponding system information and/or MAC-CE.

When carrier #1 and carrier #2 are included in the same TAG, the PCell and/or the PSCell may transmit timing information for the corresponding TAG to the IAB node. The IAB node may support simultaneous transmission and reception by applying corresponding timing information to all carriers (e.g., carrier #1 and carrier #2) included in the corresponding TAG.

As described in Embodiment #2, the corresponding timing information may be transmitted through a cell specific message such as system information or a UE group specific message such as DCI or MAC-CE.

For example, timing information may be transmitted to IAB nodes for supporting the corresponding carrier through UE group specific-DCI. In this case, the UE group specific-DCI including the timing information may be scrambled using a Random Network Temporary Identifier (RNTI) corresponding to the timing information. Thus, the IAB node may perform Cyclic Redundancy Check (CRC) check with an RNTI corresponding to the timing information, and when the CRC is checked, the IAB node may acquire the corresponding timing information from the corresponding UE group specific-DCI.

In addition, the corresponding UE group specific-DCI may be transmitted through a search space set and/or a control resource set (CORESET) configured for the corresponding UE group specific-DCI. Therefore, the IAB node may monitor the search space set and/or the control resource set (CORESET) configured for the corresponding UE group specific-DCI in order to receive the timing information from the DU before transmitting and receiving other DL/UL signals. For example, the UE group specific-DCI may be GC (Group Common)-DCI.

### 4. Embodiment #4: Timing Alignment Method in Full Duplex

It may be assumed that full duplex, which simultaneously performs DL and UL, is allowed in some of the time domains corresponding to DL among the half duplex time intervals of the existing TDD and that the time domain corresponding to the UL among the half duplex time intervals of the existing TDD maintains half duplex without changes. In this case, a time interval in which full duplex is allowed may be configured in various forms.

There may be a difference between a UL Frame boundary in the time interval where full duplex is allowed and a UL Frame boundary of the existing Half Duplex. For example, the UL frame boundary of the existing half duplex may be maintained without change, and the UL frame boundary in the time interval in which full duplex is allowed may be operated to correspond to the DL frame boundary of the existing half duplex.

In this case, the UE or the IAB-MT may apply an NTA_offset value indicated through the existing cell specific RRC signal to the UL frame boundary of the half duplex. On the other hand, when the UL frame boundary in the time resource where full duplex is allowed is determined, the NTA_offset value may be assumed to be ‘0’.

As another example, a new NTA_offset value may be defined for a UL Frame boundary in a time resource in which Full Duplex is allowed. The UE or the IAB-MT may use the existing NTA_offset value for the UL frame boundary of the existing half duplex and may use the new NTA_offset value for the UL frame boundary of the full duplex. In this case, a new NTA_offset value may be determined as a specific value. In addition, the new NTA_offset value may be indicated by a higher layer signal such as an RRC signal and/or the MAC_CE and/or the DCI.

For example, the aforementioned new NTA_offset value may be a TA value included in the timing information related to the UL Rx timing reference described in Embodiment #2. Thus, the new NTA_offset value may be transmitted through the UE group specific-DCI scrambled with an AI-RNTI, and the corresponding UE group specific-DCI may have a specific DCI format. In addition, the new NTA_offset value may be included in DCI transmitted through a specific Search Space and/or the specific Search Space Set and/or a specific CORESET. In this case, the specific Search Space and/or the specific Search Space Set and/or the specific CORESET may be commonly configured to MTs of a plurality of IAB-MTs and/or a plurality of child nodes. In addition, the new NTA_offset value may also be transferred through a cell specific RRC signal or MAC-CE. For example, the UE group specific-DCI may be GC (Group Common)-DCI.

A final TA value may be determined using a new NTA_offset value instead of the existing NTA_Offset. Alternatively, the final TA value may be determined by adding the new NTA_offset value to the existing NTA_Offset. In this case, when NTA_Offset for the UL Frame boundary in the time resource in which Full Duplex is allowed is smaller than the existing NTA_Offset, the new NTA_Offset may have a negative value. For example, in the above example, in order for the UL Frame boundary in the time interval in which Full Duplex is allowed to correspond to the DL frame boundary of the existing Half Duplex, when the final TA value needs to be 0, the new NTA_Offset may be (existing NTA_Offset).

During UL transmission at the existing UL frame boundary, the UE or the IAB-MT may apply 7.5 kHz shift according to indication of a BS or a DU of the parent node. In contrast, when the UE or the IAB-MT transmits UL in a time resource in which Full Duplex is allowed, 0 kHz shift may be applied.

According to Embodiment #4, unnecessary Cross Link Interference (CLI) due to Timing alignment may be reduced. When a Spectrum Sharing Full Duplex method is used, receive complexity may be reduced.

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

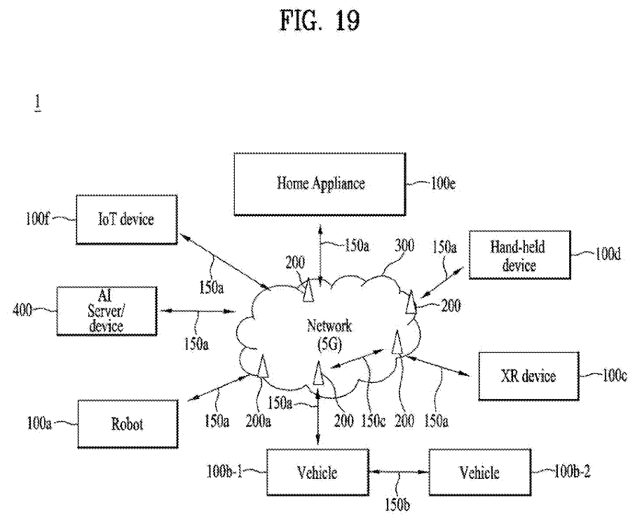

FIG. 19 illustrates a communication system 1 applied to the present disclosure.

Referring to FIG. 19, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul(IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

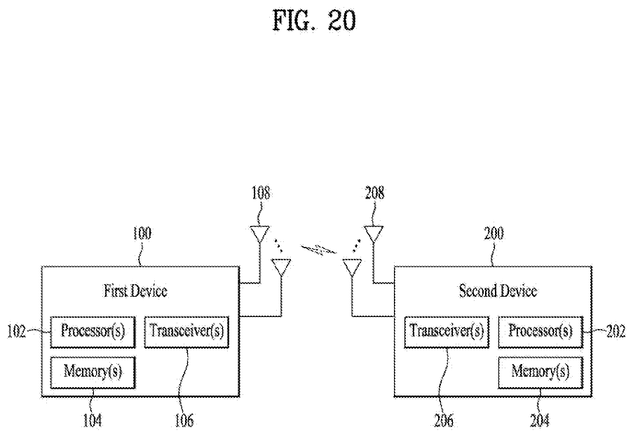

FIG. 20 illustrates wireless devices applicable to the present disclosure.

Referring to FIG. 20, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 19.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

Specifically, instructions and/or operations, controlled by the processor 102 of the first wireless device 100 and stored in the memory 104 of the first wireless device 100, according to an embodiment of the present disclosure will be described.

Although the following operations will be described based on a control operation of the processor 102 in terms of the processor 102, software code for performing such an operation may be stored in the memory 104. For example, in the present disclosure, the at least one memory 104 may be a computer-readable storage medium and may store instructions or programs. The instructions or programs may cause, when executed, the at least one processor operably connected to the at least one memory to perform operations according to embodiments or implementations of the present disclosure, related to the following operations.

In detail, the processor 102 may control the transceiver 106 to receive timing information related to UL Rx timing reference from the parent node based on Embodiment #1, Embodiment #2, and/or Embodiment #4. The processor 102 may acquire a DU Rx timing, an MT Rx timing, and an MT Tx timing of the processor 102 based on Embodiment #1, Embodiment #2, and/or Embodiment #4. The processor 102 may control the transceiver 106 to transmit the timing information related to UL Rx timing reference to the child node based on Embodiment #1, Embodiment #2, and/or Embodiment #4. In this case, the child node may acquire a DU Rx timing, an MT Rx timing, and/or an MT Tx timing of the child node based on the same operation as the processor 102.

The processor 102 may control the transceiver 106 to transmit an uplink signal to the parent node or receive a downlink signal from the parent node based on the DU Rx timing, the MT Rx timing, and/or the MT Tx timing that are aligned based on Embodiment #1, Embodiment #2, and/or Embodiment #4. The processor 102 may control the transceiver 106 to receive an uplink signal from the child node or transmit a downlink signal to the child node according to the DU Rx timing, the MT Rx timing, and/or the MT Tx timing that are aligned based on Embodiment #1, Embodiment #2, and/or Embodiment #4. If the processor 102 supports a multi-carrier operation, the aforementioned operation may be performed by further considering Embodiment #3.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Specifically, instructions and/or operations, controlled by the processor 202 of the second wireless device 100 and stored in the memory 204 of the second wireless device 200, according to an embodiment of the present disclosure will be described.

Although the following operations will be described based on a control operation of the processor 202 in terms of the processor 202, software code for performing such an operation may be stored in the memory 204. For example, in the present disclosure, the at least one memory 204 may be a computer-readable storage medium and may store instructions or programs. The instructions or programs may cause, when executed, the at least one processor operably connected to the at least one memory to perform operations according to embodiments or implementations of the present disclosure, related to the following operations.

In detail, an operation in which the processor 202 is a processor of a parent node will be described. The processor 202 may control the transceiver 206 to transmit the timing information related to the UL Rx timing reference to the IAB node based on Embodiment #1, Embodiment #2, and/or Embodiment #4. When a timing of the IAB node is aligned based on corresponding timing information, the processor may control the transceiver 206 to transmit a downlink signal to the IAB node or to receive an uplink signal from the IAB node based on Embodiment #1, Embodiment #2, and/or Embodiment #4. In addition, when the parent node supports a multi-carrier operation, the above operations of the processor may be performed by further considering Embodiment #3.

In detail, an operation in which the processor 202 is a processor of a child node will be described. The processor 202 may control the transceiver 206 to receive the timing information related to the UL Rx timing reference from the IAB node based on Embodiment #1, Embodiment #2, and/or Embodiment #4.

When timings of the parent node, the IAB node, and the child node are aligned based on the timing information, the processor 202 may control the transceiver 206 to receive a downlink signal from the IAB node or transmit an uplink signal to the IAB node according to the DU Rx timing, the MT Rx timing, and/or the MT Tx timing that are aligned based on Embodiment #1, Embodiment #2, and/or Embodiment #4. When the child node supports a multi-carrier operation, the above operations of the child node may be performed by further considering Embodiment #3.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

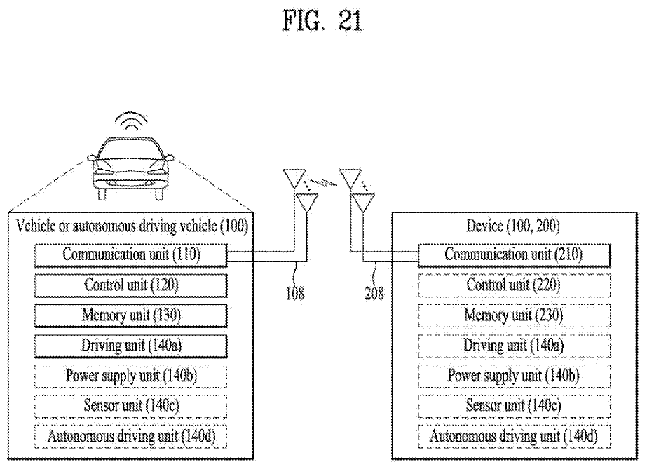

FIG. 21 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 21, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The embodiments of the present disclosure described herein below are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present disclosure or included as a new claim by a subsequent amendment after the application is filed.

In the present disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL AVAILABILITY

As described above, a method for transmitting and receiving a signal in an IAB (Integrated Access and Backhaul) node and an apparatus therefor have been described in terms of an examples applied to the 5G NewRAT system, but in addition to the 5G NewRAT system, various wireless communication systems may be applied.

1. A method of receiving an uplink signal by an Integrated Access and Backhaul (IAB) node in a wireless communication system, the method comprising:
acquiring timing information related to an uplink reception timing reference for a distributed unit (DU) of the IAB node;
receiving a first uplink signal by the DU of the IAB node based on the timing information; and
receiving a downlink signal or transmitting a second uplink signal by a mobile-termination (MT) of the IAB node based on the timing information,
wherein the receiving of the first uplink signal by the DU of the IAB node and the receiving of the downlink signal or the transmitting of the second uplink signal by the MT of the IAB node are performed in the same time resource.

2. The method of claim 1, wherein the uplink reception timing reference is determined based on a downlink reception timing of the MT of the IAB node.

3. The method of claim 1, wherein the uplink reception timing reference is determined based on a Timing Advanced (TA) value for an uplink transmission timing of the MT of the IAB node.

4. The method of claim 1, wherein the timing information is received through a user equipment (UE) group common signal from a DU of a parent node.

5. The method of claim 1, wherein the timing information is transmitted to an MT of a child node.

6. The method of claim 1, wherein the timing information includes a negative timing advanced (TA) value.

7. The method of claim 1, wherein a first timing advanced (TA) value related to an uplink frame boundary for performing the receiving of the first uplink signal and the receiving of the downlink signal or the transmitting of the second uplink signal in the same time resource, and a second timing advanced (TA) value related to an uplink frame boundary for performing the receiving of the first uplink signal and the receiving of the downlink signal or the transmitting of the second uplink signal in different time resources are different.

8. An Integrated Access and Backhaul (IAB) node for receiving an uplink signal in a wireless communication system, the IAB node comprising:
at least one transceiver;
at least one processor; and
at least one computer memory operatively connected to the at least one processor and configured to store instructions for causing the at least one processor to perform an operation when being executed, the operation including:
acquiring timing information related to an uplink reception timing reference for a distributed unit (DU) of the IAB node;
receiving a first uplink signal by the DU of the IAB node based on the timing information through the at least one transceiver; and
receiving a downlink signal or transmitting a second uplink signal by a mobile-termination (MT) of the IAB node based on the timing information through the at least one transceiver,
wherein the receiving of the first uplink signal by the DU of the IAB node and the receiving of the downlink signal or the transmitting of the second uplink signal by the MT of the IAB node are performed through the at least one transceiver in the same time resource.

9. The IAB node of claim 8, wherein the uplink reception timing reference is determined based on a downlink reception timing of the MT of the IAB node.

10. The IAB node of claim 8, wherein the uplink reception timing reference is determined based on a Timing Advanced (TA) value for an uplink transmission timing of the MT of the IAB node.

11. The IAB node of claim 8, wherein the timing information is received through a user equipment (UE) group common signal from a DU of a parent node.

12. The IAB node of claim 8, wherein the timing information is transmitted to an MT of a child node.

13. The IAB node of claim 8, wherein the timing information includes a negative timing advanced (TA) value.

14. The IAB node of claim 8, wherein a first timing advanced (TA) value related to an uplink frame boundary for performing the receiving of the first uplink signal and the receiving of the downlink signal or the transmitting of the second uplink signal in the same time resource, and a second timing advanced (TA) value related to an uplink frame boundary for performing the receiving of the first uplink signal and the receiving of the downlink signal or the transmitting of the second uplink signal in different time resources are different.

15. An apparatus for receiving an uplink signal in a wireless communication system, the apparatus comprising:
at least one processor; and
at least one computer memory operatively connected to the at least one processor and configured to store instructions for causing the at least one processor to perform an operation when being executed, the operation including:
acquiring timing information related to an uplink reception timing reference for a distributed unit (DU) of the apparatus;
receiving a first uplink signal by the DU of the apparatus based on the timing information; and
receiving a downlink signal or transmitting a second uplink signal by a mobile-termination (MT) of the apparatus based on the timing information,
wherein the receiving of the first uplink signal by the DU of the apparatus and the receiving of the downlink signal or the transmitting of the second uplink signal by the MT of the apparatus are performed in the same time resource.

16. (canceled)
